(19) United States
(12) Patent Application Publication
(10) Pub. No.: US 2017/0026102 A1
(43) Pub. Date: Jan. 26, 2017

(54) Method for mixedly indicating uplink and downlink beams, base station, terminal and system

(71) Applicant: ZTE Corporation, Shenzhen, Guangdong (CN)

(72) Inventors: Senbao GUO, Shenzhen (CN); Guanghui YU, Shenzhen (CN); Zhaohua LU, Shenzhen (CN)

(21) Appl. No.: 15/105,477

(22) PCT Filed: Jul. 1, 2014
(86) PCT No.: PCT/CN2014/081412

§ 371 Date: Sep. 20, 2016

(30) Foreign Application Priority Data
Dec. 20, 2013 (CN) 201310714911.6

(51) Int. Cl. H04B 7/06; H04B 7/08; H04W 72/04

(52) U.S. Cl. CPC H04B 7/0695; H04W 72/0413; H04W 72/042; H04B 7/0639; H04B 7/0897

(57) ABSTRACT

Disclosed is a method for mixedly indicating uplink and downlink beams, comprising: a base station notifies correlations between properties of an uplink access signal and an uplink beam index and/or downlink beam index in a preset manner and/or in a manner of system message configuration, wherein the properties of the uplink access signal are used for indicating the uplink beam index and/or downlink beam index for sending the uplink access signal; and after receiving the uplink access signal, the base station obtains the uplink beam index and/or downlink beam index by recognizing the properties of the uplink access signal. Further disclosed at the same time are a base station, terminal and system for realizing the method.

### TECHNICAL FIELD

The disclosure relates to a Long Term Evolution Advanced (LTE-Advanced) system in the field of mobile communication, and in particular to a method, a base station, a terminal and a system for mixedly indicating uplink and downlink beams.

### BACKGROUND

During high-frequency communication, adoption of a higher carrier frequency for transmission may cause average path loss much higher than that of a conventional LTE system, and for example: if a carrier frequency of 28 GHz is adopted for transmission, by virtue of formula:

$${L}_{f} = {( \frac{4 π R}{λ} )}^{2} ,$$

average proportion information of a high-frequency path loss value L_{H} and an LTE path loss value L_{L} may be calculated as:

$${L}_{H} / {L}_{L} = {( \frac{4 π R}{{λ}_{H}} )}^{2} / {( \frac{4 π R}{{λ}_{L}} )}^{2} = {( \frac{{λ}_{L}}{{λ}_{H}} )}^{2} \approx 100.$$

During high-frequency communication, for ensuring coverage, in which case a receiving side meets a requirement of minimum Signal to Interference plus Noise Ratio (SINR), it is necessary to increase a gain Pᵣ of a transceiver:

$${P}_{r} = {P}_{t} {G}_{t} {{G}_{r} ( \frac{λ}{4 π R} )}^{2} = {P}_{t} {G}_{t} {G}_{r} / {L}_{f} .$$

In the formula, R is a coverage radius of cell, λ is a wavelength of a corresponding carrier, Gₜ is a gain of a sending antenna and Gᵣ is a gain of a receiving antenna.

LTE communication requires area coverage which maximally reaches 100 km, and in case of maximum coverage, if only average path loss (an empty area) is considered, area coverage which maximally reaches 1 km may be considered for high-frequency communication. If the characteristics of high air absorption (oxygen absorption, rain fading and fog fading), shadow fading sensitivity and the like of an actual high-frequency carrier are considered, actually supported coverage is smaller than 1 km.

If high-frequency communication supports maximum coverage of 1 km, an SINR different from that of an LTE system may be obtained by the high-frequency communication for the same coverage area, a signal to noise ratio of the high-frequency communication is at least 20 dB lower than that of the LTE, and in order to ensure that high-frequency communication and the LTE system have an approximate SINR within the same coverage, it is necessary to ensure an antenna gain of high-frequency communication. Then, more antenna elements may be accommodated on a unit area since high-frequency communication has a smaller wavelength, and more antenna elements may provide a higher antenna gain, thereby ensuring coverage performance of high-frequency communication.

The accommodation of the more antenna elements means that a beamforming method may be adopted to ensure coverage of high-frequency communication. From an early design concept of LTE, it is necessary to accurately obtain state information of a channel so as to obtain a beamforming weight from the state information of the channel, thereby achieving a good effect of the beamforming. In order to obtain a better beamforming weight, a terminal serving as a receiver is required to feed back state information or a weight of downlink channel to a base station serving as a sender, and the base station is required to feed back state information or a weight of uplink channel to the receiver, so that it is ensured that the base station may send a downlink traffic by adopting an optimal beam and the terminal may send an uplink traffic by adopting an optimal beam. In such case, there exists a problem as follows: the base station cannot cover the terminal by virtue of the optimal beam before obtaining the weight, so that the terminal may not measure a reference signal sent by the base station; or even though the base station covers the terminal, the terminal may not achieve coverage the same as that of the base station and a fed-back content may not be acquired by the base station, so that beamforming weight selection and normal communication are also impossible.

### SUMMARY

In order to solve the existing technical problem, the embodiment of the disclosure provides a method, a base station, a terminal and a system for mixedly indicating uplink and downlink beams.

The embodiment of the disclosure provides a method for mixedly indicating uplink and downlink beams, which may include that:

a base station notifies a corresponding relationship between a characteristic of an uplink access signal and an index of an uplink beam and/or an index of a downlink beam in a manner of presetting and/or a manner of system message configuration, the characteristic of the uplink access signal indicating the index of the uplink beam for sending the uplink access signal, and/or the index of the downlink beam; and

the base station identifies the characteristic of the uplink access signal to obtain the index of the uplink beam and/or the index of the downlink beam after receiving the uplink access signal.

The embodiment of the disclosure further provides a method for mixedly indicating uplink and downlink beams, which may include that:

a terminal sends an uplink access signal after obtaining a corresponding relationship between a characteristic of the uplink access signal and an index of an uplink beam and/or an index of a downlink beam in a manner of presetting and/or a manner of receiving system message configuration, the characteristic of the uplink access signal indicating the index of the uplink beam corresponding to an uplink beam for the terminal to send the uplink access signal, and/or the index of the downlink beam to be fed back.

The embodiment of the disclosure further provides a method for mixedly indicating uplink and downlink beams, which may include that:

a base station notifies a corresponding relationship between a characteristic of an uplink access signal and an index of an uplink beam and/or an index of a downlink beam to a terminal in a manner of presetting and/or a manner of system message configuration, the characteristic of the uplink access signal indicating the index of the uplink beam for the terminal to send the uplink access signal, and/or the index of the downlink beam; and

the base station identifies the characteristic of the uplink access signal to obtain the index of the uplink beam and/or the index of the downlink beam after receiving the uplink access signal sent by the terminal.

The embodiment of the disclosure further provides a base station, which may include: a configuration sending module and a receiving identification module, wherein

the configuration sending module may be configured to notify a corresponding relationship between a characteristic of an uplink access signal and an index of an uplink beam and/or an index of a downlink beam in a manner of presetting and/or a manner of system message configuration, the characteristic of the uplink access signal indicating the index of the uplink beam for sending the uplink access signal, and/or the index of the downlink beam; and

the receiving identification module may be configured to identify the characteristic of the uplink access signal to obtain the index of the uplink beam and/or the index of the downlink beam after receiving the uplink access signal.

The embodiment of the disclosure further provides a terminal, which may include: a receiving module and a sending module, wherein

the receiving module may be configured to obtain a corresponding relationship between a characteristic of an uplink access signal and an index of an uplink beam and/or an index of a downlink beam in a manner of presetting and/or a manner of receiving system message configuration; and

the sending module may be configured to send the uplink access signal, the characteristic of the uplink access signal indicating the index of the uplink beam corresponding to an uplink beam for the terminal to send the uplink access signal, and/or the index of the downlink beam to be fed back.

The embodiment of the disclosure further provides a system for mixedly indicating uplink and downlink beams, which may include: the abovementioned base station and terminal.

The embodiment of the disclosure further provides a computer storage medium having stored therein a computer program for executing the abovementioned method for mixedly indicating uplink and downlink beams at the base station side or the abovementioned method for mixedly indicating uplink and downlink beams at the terminal side.

According to the method, base station, terminal and system for mixedly indicating uplink and downlink beams provided by the embodiment of the disclosure, the base station notifies the corresponding relationship between the characteristic of the uplink access signal and the index of the uplink beam and/or the index of the downlink beam to the terminal in the manner of presetting and/or the manner of system message configuration, the characteristic of the uplink access signal indicating the index of the uplink beam for sending the uplink access signal, and/or the index of the downlink beam; and the base station identifies the characteristic of the uplink access signal to obtain the index of the uplink beam and/or the index of the downlink beam after receiving the uplink access signal sent by the terminal. In such a manner, the base station may obtain an optimal downlink beam fed back by the terminal, thereby ensuring subsequent reliable transmission of downlink control information. In addition, if an uplink beam transmission is introduced, the base station may detect an uplink access signal, with optimal uplink access signal quality, of the terminal and then notify a corresponding index to the terminal, and the terminal may obtain an optimal uplink beam from the terminal to the base station by obtaining the index of the uplink beam.

### BRIEF DESCRIPTION OF THE DRAWINGS

FIG. 1 is a flowchart of an implementation of a method for mixedly indicating uplink and downlink beams according to an embodiment of the disclosure;

FIG. 2 is a flowchart of an implementation of a method for mixedly indicating uplink and downlink beams according to another embodiment of the disclosure;

FIG. 3 is a diagram of a case where indexes of uplink and downlink beams are indicated with time-domain positions according to an embodiment of the disclosure;

FIG. 4 is a diagram of a case where indexes of uplink and downlink beams are indicated with frequency-domain positions according to an embodiment of the disclosure;

FIG. 5 is a diagram of a case where indexes of uplink and downlink beams are indicated jointly with time-domain and frequency-domain positions according to an embodiment of the disclosure;

FIG. 6 is a diagram of a case where indexes of uplink and downlink beams are indicated with a time-domain and frequency-domain position joint sequence set according to an embodiment of the disclosure;

FIG. 7 is a diagram of a case where indexes of uplink and downlink beams are indicated with indicator bit information of an uplink access signal or a beam identification sequence according to an embodiment of the disclosure;

FIG. 8 is a diagram of a structure of a base station according to an embodiment of the disclosure;

FIG. 9 is a diagram of a structure of a terminal according to an embodiment of the disclosure; and

FIG. 10 is a diagram of a structure of a system according to an embodiment of the disclosure.

### DETAILED DESCRIPTION

It can be seen that an optimal method for solving the existing problem is to add a discovery process, by which a base station and a terminal may discover each other, thereby implementing communication with optimal weights.

Simply speaking, a discovery process is actually a training process, i.e. a process that a sender sends multiple beam sequences (discovery signals) in advance to enable a receiver to detect the sequences to obtain beam sequence numbers and perform feedback. A beam index selected by the terminal is an index corresponding to an optimal beam, arriving at the terminal, of the base station, and the terminal feeds back the index to ensure reliability and optimal transmission performance of data transmission from the base station to the terminal. After the terminal finishes feeding back the beam index, the base station may select an optimal beam to transmit downlink data to the terminal by virtue of the beam index.

When the terminal is required to send uplink data to the base station, it is also necessary to ensure substantially the same coverage, and then the terminal is also required to send the uplink data in a beam manner, so that coverage and transmission reliability of an uplink are ensured on one hand, and on the other hand, average sending power of the terminal may be reduced, and the purpose of saving energy may also be achieved for the terminal.

Since the terminal does not know an optimal uplink beam to the base station, it is also necessary to carry out an uplink beam training process. The terminal identifies different uplink beams by adopting different characteristics of uplink access signals, and the base station may notify an index of an optimal uplink beam to the terminal in a feedback manner, so that the terminal may send uplink data to the base station by virtue of the optimal uplink beam.

During a practical system application, the concept of beam refers to that: a beam may reduce leakage of signal power of a base station in a useless direction, ensures the characteristic of concentration of the signal power and expands coverage of the base station and a terminal, and an uplink beam may reduce power consumption of the terminal.

In the embodiment of the disclosure: a base station notifies a corresponding relationship between a characteristic of an uplink access signal and an index of an uplink beam and/or an index of a downlink beam to a terminal in a manner of presetting and/or a manner of system message configuration, the characteristic is used for indicating the index of the uplink beam for the terminal to send the uplink access signal, and/or the index of the downlink beam; and the base station identifies the characteristic of the uplink access signal to obtain the index of the uplink beam and/or the index of the downlink beam after receiving the uplink access signal sent by the terminal.

In such case, the index of the uplink beam refers to an index corresponding to an uplink beam adopted by the terminal when the terminal sends the uplink access signal; and the index of the downlink beam refers to a beam index corresponding to an optimal downlink beam selected by the terminal by receiving downlink signals according to a specific rule.

There are many rule definition methods for the specific rule, and for example: a definition method for achieving an optimal signal quality or a definition method for achieving an optimal signal power may be adopted.

A set of uplink access signal sequences includes at least one uplink access signal sequence.

The index of the downlink beam is configured to enable the base station to find a corresponding beam, and related information of the index may be actually fed back, for example: a time-domain position index, a frequency-domain position index, a downlink signal sequence index or a value equivalent to these indexes. Any indexes which may be related or equivalent to the index of the downlink beam in the disclosure fall within the scope of protection of the disclosure.

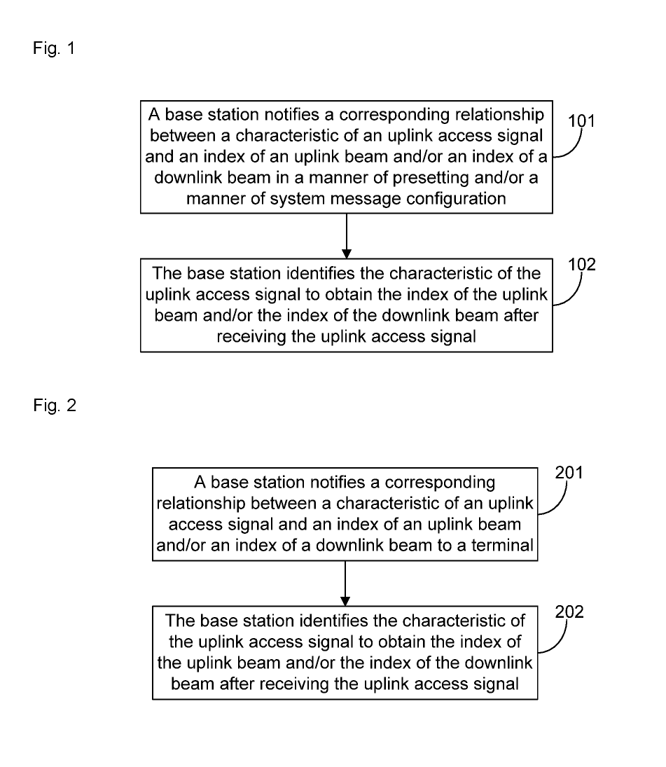

The embodiment of the disclosure provides a method for mixedly indicating uplink and downlink beams, and as shown in FIG. 1, the method includes:

Step 101: a base station notifies a corresponding relationship between a characteristic of an uplink access signal and an index of an uplink beam and/or an index of a downlink beam in a manner of presetting and/or a manner of system message configuration, the characteristic of the uplink access signal is used for indicating the index of the uplink beam for sending the uplink access signal, and/or the index of the downlink beam; and

Step 102: the base station identifies the characteristic of the uplink access signal to obtain the index of the uplink beam and/or the index of the downlink beam after receiving the uplink access signal.

In such case, the characteristic of the uplink access signal includes at least one of: a time-domain position of the uplink access signal, a frequency-domain position of the uplink access signal, a set of sequences adopted for the uplink access signals, bit information for indicating index carried after the uplink access signal and a beam identification sequence carried after the uplink access signal.

In such case, a method for the base station to identify the index of the uplink beam and/or the index of the downlink beam includes at least one of that:

identification is performed through the time-domain position of the received uplink access signal;

identification is performed through the frequency-domain position of the received uplink access signal;

identification is performed through the set of sequences adopted for the received uplink access signals;

identification is performed through the bit information for indicating index carried after the received uplink access signal; and

identification is performed through the beam identification sequence carried after the received uplink access signal.

Preferably, when the base station identifies the index of the uplink beam and/or the index of the downlink beam through the time-domain position, the method further includes that:

the base station adds a corresponding relationship between the time-domain position and the index of the uplink beam and/or the index of the downlink beam into a system message when configuring the system message.

Preferably, when the base station identifies the index of the uplink beam and/or the index of the downlink beam through the frequency-domain position, the method further includes that:

the base station adds a corresponding relationship between the frequency-domain position and the index of the uplink beam and/or the index of the downlink beam into the system message when configuring the system message.

Preferably, when the base station identifies the index of the uplink beam and/or the index of the downlink beam through a sequence adopted for an uplink access signal, the method further includes that:

the base station adds a corresponding relationship between the set of sequences adopted for the uplink access signals and the index of the uplink beam and/or the index of the downlink beam into the system message when configuring the system message.

The embodiment of the disclosure further provides another method for mixedly indicating uplink and downlink beams, which includes that:

a terminal sends an uplink access signal after obtaining a corresponding relationship between a characteristic of the uplink access signal and an index of an uplink beam and/or an index of a downlink beam in a manner of presetting and/or a manner of receiving system message configuration, the characteristic of the uplink access signal indicating the index of the uplink beam corresponding to an uplink beam for the terminal to send the uplink access signal, and/or the index of the downlink beam to be fed back.

In such case, the index of the uplink beam refers to an index corresponding to an uplink beam adopted by the terminal when the terminal sends the uplink access signal; and the index of the downlink beam refers to a beam index corresponding to an optimal downlink beam selected by the terminal by receiving downlink signals according to a specific rule.

In such case, the characteristic of the uplink access signal includes at least one of: a time-domain position of the uplink access signal, a frequency-domain position of the uplink access signal, a set of sequences adopted for the uplink access signals, bit information for indicating index carried after the uplink access signal and a beam identification sequence carried after the uplink access signal.

In such case, a method for the terminal to indicate the index of the uplink beam and/or the index of the downlink beam includes at least one of that:

the uplink access signal is sent at a preset time-domain position;

the uplink access signal is sent at a preset frequency-domain position;

a corresponding sequence is selected from a preset set of sequences to send the uplink access signal according to the set of sequences;

the bit information indicating the index of the uplink beam and/or the index of the downlink beam is carried when sending the uplink access signal; and

the beam identification sequence configured to indicate the index of the uplink beam and/or the index of the downlink beam is carried when sending the uplink access signal.

Preferably, the method further includes that:

the terminal obtains a beam indication manner in a manner of presetting.

Preferably, the method further includes that:

the terminal obtains the beam indication manner through a received system message configuration.

Preferably, when the terminal indicates the index of the uplink beam and/or the index of the downlink beam by virtue of the time-domain position where sending the uplink access signal, the method further includes that:

the terminal obtains a corresponding relationship between the time-domain position and the index of the uplink beam and/or the index of the downlink beam from a system message after receiving the system message.

Preferably, when the terminal indicates the index of the uplink beam and/or the index of the downlink beam by virtue of the frequency-domain position where sending the uplink access signal, the method further includes that:

the terminal obtains a corresponding relationship between the frequency-domain position and the index of the uplink beam and/or the index of the downlink beam from the system message after receiving the system message.

Preferably, when the terminal indicates the index of the uplink beam and/or the index of the downlink beam by virtue of a sequence adopted for an uplink access signal, the method further includes that:

the terminal obtains a corresponding relationship between the sequence set adopted for the uplink access signal and the index of the uplink beam and/or the index of the downlink beam from the system message after receiving the system message.

The embodiment of the disclosure further provides another method for mixedly indicating uplink and downlink beams, and as shown in FIG. 2, the method includes:

Step 201: a base station notifies a corresponding relationship between a characteristic of an uplink access signal and an index of an uplink beam and/or an index of a downlink beam to a terminal in a manner of presetting and/or a manner of system message configuration, the characteristic of the uplink access signal indicating the index of the uplink beam for sending the uplink access signal, and/or the index of the downlink beam to the terminal; and

Step 202: the base station identifies the characteristic of the uplink access signal to obtain the index of the uplink beam and/or the index of the downlink beam after receiving the uplink access signal sent by the terminal.

In such case, the characteristic of the uplink access signal includes at least one of: a time-domain position of the uplink access signal, a frequency-domain position of the uplink access signal, a set of sequences adopted for the uplink access signals, bit information for indicating index carried after the uplink access signal and a beam identification sequence carried after the uplink access signal.

Preferably, the method further includes that:

the base station sets a beam identification manner consistent with that adopted by the terminal in the manner of presetting or in the manner of system message configuration.

Preferably, the method further includes that:

the base station notifies a beam indication manner to be adopted to the terminal in the manner of presetting or in the manner of system message configuration.

In such case, the step that the base station notifies the beam indication manner in the manner of system message configuration includes that:

the base station carries configuration information of N beam indication manners by virtue of a system message sent via S beams, wherein S>0 and N>0.

Preferably, when the characteristic of the uplink access signal is the time-domain position of the uplink access signal, the method further includes that:

the base station and the terminal set a corresponding relationship between the time-domain position and the index of the uplink beam and/or the index of the downlink beam in a manner of presetting.

Preferably, when the characteristic of the uplink access signal is the frequency-domain position of the uplink access signal, the method further includes that:

the base station and the terminal set a corresponding relationship between the frequency-domain position and the index of the uplink beam and/or the index of the downlink beam in a manner of presetting.

Preferably, when the characteristic of the uplink access signal is a sequence of the set of sequences adopted for the uplink access signals, the method further includes that:

the base station and the terminal set a corresponding relationship between the set of sequences adopted for the uplink access signals and the index of the uplink beam and/or the index of the downlink beam in a manner of presetting.

Preferably, the method further includes that:

when the base station and the terminal do not preset a corresponding relationship between the characteristic of the uplink access signal and an uplink beam and the base station does not notify the corresponding relationship between the characteristic of the uplink access signal and the uplink beam to the terminal in the manner of system message configuration, the terminal carries the index of the uplink beam in the characteristic of the uplink access signal corresponding to the index of the downlink beam.

Here, it should be noted that the terminal is required to know the corresponding relationship between the uplink beam the characteristic of the uplink access signal carrying the index of the uplink beam, and the base station is not required to acquire the relationship.

The disclosure will be further described with reference to the drawings and specific embodiments in detail.

### Embodiment 1

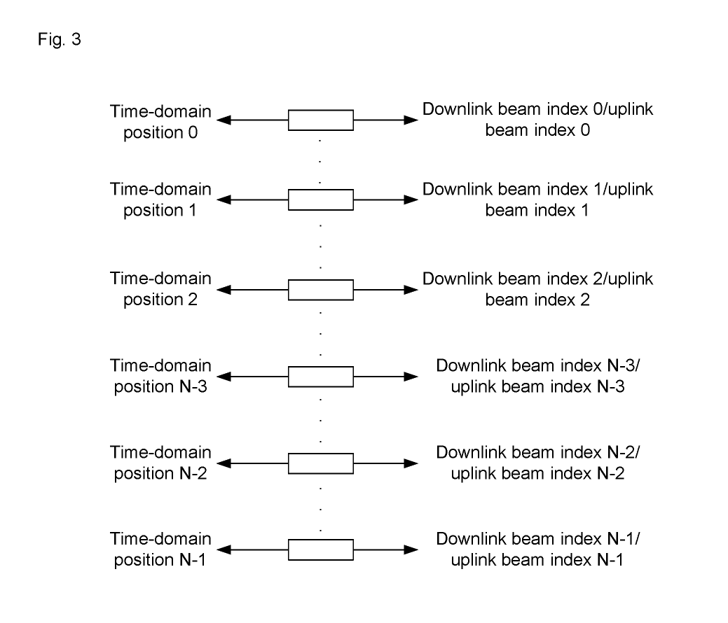

It is assumed that a base station sends a downlink synchronization signal and/or downlink system information by virtue of N downlink beams such that an area required to be covered by the base station may substantially be covered. A terminal sends uplink data to the base station by virtue of M uplink beams. N downlink beam indexes and M uplink beam indexes form N*M joint beam indexes. The base station and the terminal preset that N*M time-domain positions correspond to the N*M joint beam indexes respectively. Or, the base station notifies a corresponding relationship between the N*M time-domain positions and the N*M joint beam indexes to the terminal through a system message. The base station detects uplink access signals of the terminal at one or more time-domain positions to obtain downlink beam indexes and uplink beam indexes corresponding to the terminal. If the terminal wants to obtain the corresponding relationship between the N*M time-domain positions and the N*M joint beam indexes respectively through the system message, the terminal is required to receive the system message to obtain the corresponding relationship at first. After obtaining an index of an optimal downlink beam of the base station, the terminal sends an uplink access signal to carry the index of the downlink beam and an index of an uplink beam at the corresponding time-domain position. The base station detects the uplink access signal with optimal signal quality sent from the terminal, and obtains the corresponding downlink beam index and uplink beam index according to the time-domain position of the uplink access signal, for example, as shown in FIG. 3. In such case, the time-domain positions may include a set of multiple time units. The time-domain positions include occupied time unit indexes and/or duration levels. In such case, the duration levels may be reflected by the numbers of included time units. In such case, the duration levels may also be time-domain repeat levels of the uplink access signals.

Sub-Embodiment 1

It is assumed that the base station sends the downlink synchronization signal and/or the downlink system information by virtue of 8 beams, and the area required to be covered by the base station may substantially be covered. The terminal may transmit the uplink data by virtue of 8 beams. 8 downlink beam indexes and 8 uplink beam indexes form 64 joint beam indexes. The base station and the terminal preset that 64 time-domain positions correspond to the 64 joint beam indexes respectively, or the base station notifies the terminal that the 64 time-domain positions correspond to the 64 joint beam indexes respectively through a system message, as shown in Table 1. In such case, the time-domain positions include occupied time unit indexes and/or duration levels. In such case, the duration levels may be reflected by the numbers of included time units. In such case, the duration levels may also be the time-domain repeat levels of the uplink access signals.

TABLE 1

| Downlink beam | Time-domain position |
|---|---|
| index&uplink beam | where the uplink |
| index--joint beam index | access signal is sent |
| 0&0--0 | Time-domain position 0 |
| 0&1--1 | Time-domain position 1 |
| . . . | . . . |
| 0&7--7 | Time-domain position 7 |
| 1&0--8 | Time-domain position 8 |
| 1&1--9 | Time-domain position 9 |
| . . . | . . . |
| 1&7--15 | Time-domain position 15 |
| . . . | . . . |
| 7&6--62 | Time-domain position 62 |
| 7&7--63 | Time-domain position 63 |

The terminal detects the downlink signal to obtain index 1 of an optimal downlink beam, and the terminal selects time-domain positions 8˜15 to send the uplink access signals.

The base station detects the uplink access signals at multiple time-domain positions, and when the base station detects the uplink access signal with optimal quality at time-domain position 14, the base station obtains downlink beam index 1 and uplink beam index 6 corresponding to an optimal uplink beam for the terminal, further obtains an optimal beam for the base station to send downlink data to the terminal according to the index of the downlink beam, and obtains an optimal beam for the terminal to send the uplink data to the base station according to the index of the uplink beam.

Sub-Embodiment 2

It is assumed that the base station sends the downlink synchronization signal and/or the downlink system information by virtue of 8 beams, such that the area required to be covered by the base station may substantially be covered. The terminal may transmit the uplink data by virtue of 8 beams. 8 downlink beam indexes and 8 uplink beam indexes form 64 joint beam indexes. The base station and the terminal preset that duration levels of 64 uplink access signals correspond to the 64 joint beam indexes respectively, or the base station notifies the terminal that the duration levels of the 64 uplink access signals correspond to the 64 joint beam indexes respectively through a system message, as shown in Table 2. In such case, the duration levels may be reflected by the numbers of included time units. In such case, the duration levels may also be the time-domain repeat levels of the uplink access signals.

TABLE 2

| Downlink beam | Time-domain position |
|---|---|
| index&uplink beam | where the uplink |
| index--joint beam index | access signal is sent |
| 0&0--0 | Duration level 0 |
| 0&1--1 | Duration level 1 |
| . . . | . . . |
| 0&7--7 | Duration level 7 |
| 1&0--8 | Duration level 8 |
| 1&1--9 | Duration level 9 |
| . . . | . . . |
| 1&7--15 | Duration level 15 |
| . . . | . . . |
| 7&6--62 | Duration level 62 |
| 7&7--63 | Duration level 63 |

The terminal detects the downlink signal to obtain an index 1 of an optimal downlink beam, and the terminal selects duration levels 8˜15 to send the uplink access signals.

The base station detects the uplink access signals at multiple time-domain positions, and when the base station detects that the uplink access signal with optimal quality adopts duration level 14, the base station obtains downlink beam index 1 and uplink beam index 6 corresponding to the optimal uplink beam for the terminal, further obtains the optimal beam for the base station to send the downlink data to the terminal according to the index of the downlink beam, and obtains the optimal beam for the terminal to send the uplink data to the base station according to the index of the uplink beam.

### Embodiment 2

It is assumed that a base station sends a downlink synchronization signal and/or downlink system information by virtue of N downlink beams such that an area required to be covered by the base station may substantially be covered. A terminal may send uplink data to the base station by virtue of M uplink beams. The base station and the terminal preset that N time-domain positions correspond to N downlink beam indexes respectively, and the base station and the terminal preset that M time-domain positions correspond to M downlink beam indexes respectively. Or, the base station notifies the terminal that the N time-domain positions correspond to the N downlink beam indexes respectively through a system message, and the base station and the terminal preset that the M time-domain positions correspond to the M downlink beam indexes respectively. In such case, the time-domain positions corresponding to the indexes of the downlink beams are called downlink beam time-domain positions, and the time-domain positions corresponding to the indexes of the uplink beams are called uplink beam time-domain positions. In such case, the downlink beam time-domain positions are sets of multiple time units or duration levels, and the uplink beam time-domain positions are subsets of the downlink beam time-domain positions. Or, the uplink beam time-domain positions are sets of multiple time units or duration levels, and the downlink beam time-domain positions are subsets of the downlink beam time-domain positions.

The base station detects uplink access signals of the terminal at one or more time-domain positions to obtain downlink beam indexes and uplink beam indexes corresponding to the terminal. If the terminal wants to obtain such a corresponding relationship through the system message, the terminal is required to receive the system message to obtain the corresponding relationship at first. After obtaining an index of an optimal downlink beam of the base station, the terminal sends an uplink access signal to carry the index of the downlink beam and an index of an uplink beam at the corresponding time-domain position. The base station detects the uplink access signal with optimal signal quality sent from the terminal, and obtains the corresponding downlink beam index and uplink beam index according to the time-domain position of the uplink access signal, for example, as shown in FIG. 3. In such case, the time-domain positions may include multiple time unit sets. The time-domain positions include occupied time unit indexes and/or duration levels. In such case, the duration levels may be reflected by the numbers of included time units. In such case, the duration levels may also be time-domain repeat levels of the uplink access signals.

Sub-Embodiment 1

It is assumed that the base station sends the downlink synchronization signal and/or the downlink system information by virtue of 8 beams, such that the area required to be covered by the base station may substantially be covered. The terminal may transmit the uplink data by virtue of 8 beams. 8 downlink beam indexes and 8 uplink beam indexes form 64 joint beam indexes. The base station and the terminal preset that 8 time-domain positions correspond to 8 downlink beam indexes respectively, and the base station and the terminal preset that 8 time-domain positions correspond to 8 downlink beam indexes respectively. Or, the base station notifies the terminal that the 8 time-domain positions correspond to the 8 downlink beam indexes respectively through a system message, and the base station and the terminal preset that the 8 time-domain positions correspond to the 8 downlink beam indexes respectively. In such case, the time-domain positions corresponding to the indexes of the downlink beams are called downlink beam time-domain positions, and the time-domain positions corresponding to the indexes of the uplink beams are called uplink beam time-domain positions, as shown in Table 3.

TABLE 3

| Downlink beam | Time-domain position |
|---|---|
| index&uplink beam | where the uplink |
| index--joint beam index | access signal is sent |
| 0&0--0 | Time-domain position 0 |
| 0&1--1 | Time-domain position 1 |
| . . . | . . . |
| 0&7--7 | Time-domain position 7 |
| 1&0--8 | Time-domain position 8 |
| 1&1--9 | Time-domain position 9 |
| . . . | . . . |
| 1&7--15 | Time-domain position 15 |
| . . . | . . . |
| 7&6--62 | Time-domain position 62 |
| 7&7--63 | Time-domain position 63 |

The terminal detects the downlink signal to obtain an index 1 of an optimal downlink beam, and the terminal selects time-domain positions 8˜15 to send the uplink access signals.

The base station detects the uplink access signals at multiple time-domain positions, and when the base station detects the uplink access signal with optimal quality at time-domain position 14, the base station obtains downlink beam index 1 and uplink beam index 6 corresponding to an optimal uplink beam for the terminal, further obtains an optimal beam for the base station to send downlink data to the terminal according to the index of the downlink beam, and obtains an optimal beam for the terminal to send the uplink data to the base station according to the index of the uplink beam.

### Embodiment 3

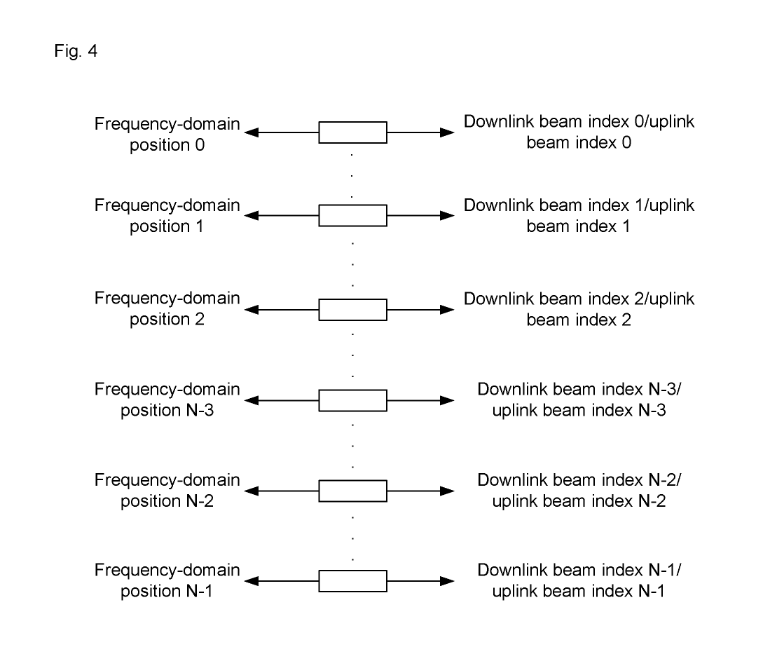

It is assumed that a base station sends a downlink synchronization signal and/or downlink system information by virtue of N downlink beams such that an area required to be covered by the base station may substantially be covered. A terminal may send uplink data to the base station by virtue of M uplink beams. N downlink beam indexes and M uplink beam indexes form N*M joint beam indexes. The base station and the terminal preset that N*M frequency-domain positions correspond to the N*M joint beam indexes respectively. Or, the base station notify the terminal the corresponding relationship between N*M frequency-domain positions and the N*M joint beam indexes through a system message. The base station detects uplink access signals of the terminal at one or more frequency-domain positions to obtain downlink beam indexes and uplink beam indexes corresponding to the terminal. If the terminal wants to obtain the corresponding relationship between the N*M frequency-domain positions and the N*M joint beam indexes respectively through the system message, the terminal is required to receive the system message to obtain the corresponding relationship at first. After obtaining an index of an optimal downlink beam of the base station, the terminal sends an uplink access signal to carry the index of the downlink beam and an index of an uplink beam at the corresponding frequency-domain position. The base station detects the uplink access signal with optimal signal quality sent from the terminal, and obtains the corresponding downlink beam index and uplink beam index according to the frequency-domain position of the uplink access signal, for example, as shown in FIG. 4. In such case, the frequency-domain positions include starting frequency-domain positions where the uplink access signals are sent and/or frequency-domain bandwidths occupied by the uplink access signals.

Sub-Embodiment 1

It is assumed that the base station sends the downlink synchronization signal and/or the downlink system information by virtue of 8 beams, such that the area required to be covered by the base station may substantially be covered. The terminal may transmit the uplink data by virtue of 8 beams. 8 downlink beam indexes and 8 uplink beam indexes form 64 joint beam indexes. The base station and the terminal preset that 64 frequency-domain positions correspond to the 64 joint beam indexes respectively, or the base station notifies the terminal that the 64 frequency-domain positions correspond to the 64 joint beam indexes respectively through a system message, as shown in Table 4. In such case, the frequency-domain positions include starting frequency-domain positions where the uplink access signal are sent and/or frequency-domain bandwidths occupied by the uplink access signals.

TABLE 4

| Downlink beam | Frequency-domain position |
|---|---|
| index&uplink beam | where the uplink |
| index--joint beam index | access signal is sent |
| 0&0--0 | Frequency-domain position 0 |
| 0&1--1 | Frequency-domain position 1 |
| . . . | . . . |
| 0&7--7 | Frequency-domain position 7 |
| 1&0--8 | Frequency-domain position 8 |
| 1&1--9 | Frequency-domain position 9 |
| . . . | . . . |
| 1&7--15 | Frequency-domain position 15 |
| . . . | . . . |
| 7&6--62 | Frequency-domain position 62 |
| 7&7--63 | Frequency-domain position 63 |

The terminal detects the downlink signal to obtain an index 1 of an optimal downlink beam, and the terminal selects frequency-domain positions 8˜15 to send the uplink access signals.

The base station detects the uplink access signals at multiple frequency-domain positions, and when the base station detects the uplink access signal with optimal quality at frequency-domain position 14, the base station obtains downlink beam index 1 and uplink beam index 6 corresponding to an optimal uplink beam for the terminal, further obtains an optimal beam for the base station to send downlink data to the terminal according to the index of the downlink beam, and obtains an optimal beam for the terminal to send the uplink data to the base station according to the index of the uplink beam.

### Embodiment 4

It is assumed that a base station sends a downlink synchronization signal and/or downlink system information by virtue of N downlink beams such that an area required to be covered by the base station may substantially be covered. A terminal may send uplink data to the base station by virtue of M uplink beams. The base station and the terminal preset that N frequency-domain positions correspond to N downlink beam indexes respectively, and the base station and the terminal preset that M frequency-domain positions correspond to M uplink beam indexes respectively. Or, the base station notifies the terminal that the N frequency-domain positions correspond to the N downlink beam indexes respectively through a system message, and the base station and the terminal preset that the M frequency-domain positions correspond to the M uplink beam indexes respectively. In such case, the frequency-domain positions corresponding to the indexes of the downlink beams are called downlink beam frequency-domain positions, and the frequency-domain positions corresponding to the indexes of the uplink beams are called uplink beam frequency-domain positions. In such case, the downlink beam frequency-domain positions are sets of multiple starting frequency-domain positions and/or bandwidth levels, and the uplink beam frequency-domain positions are subsets of the uplink beam frequency-domain positions. Or, the downlink beam frequency-domain positions are sets of multiple starting frequency-domain positions and/or bandwidth levels, and the uplink beam frequency-domain positions are subsets of the uplink beam frequency-domain positions.

The base station detects uplink access signals of the terminal at one or more frequency-domain positions to obtain downlink beam indexes and uplink beam indexes corresponding to the terminal. If the terminal wants to obtain such a corresponding relationship through the system message, the terminal is required to receive the system message to obtain the corresponding relationship at first. After obtaining an index of an optimal downlink beam of the base station, the terminal sends an uplink access signal to carry the index of the downlink beam and an index of an uplink beam at the corresponding frequency-domain position. The base station detects the uplink access signal with optimal signal quality sent from the terminal, and obtains the corresponding downlink beam index and uplink beam index according to the frequency-domain position of the uplink access signal, for example, as shown in FIG. 4. In such case, the frequency-domain positions may include multiple starting frequency-domain position and/or bandwidth level sets.

Sub-Embodiment 1

It is assumed that the base station sends the downlink synchronization signal and/or the downlink system information by virtue of 8 beams, such that the area required to be covered by the base station may substantially be covered. The terminal may transmit the uplink data by virtue of 8 beams. 8 downlink beam indexes and 8 uplink beam indexes form 64 joint beam indexes. The base station and the terminal preset that 8 frequency-domain positions correspond to 8 downlink beam indexes respectively, and the base station and the terminal preset that 8 frequency-domain positions correspond to 8 downlink beam indexes respectively. Or, the base station notifies the terminal that the 8 frequency-domain positions correspond to the 8 downlink beam indexes respectively through a system message, and the base station and the terminal preset that the 8 frequency-domain positions correspond to the 8 downlink beam indexes respectively. In such case, the frequency-domain positions corresponding to the indexes of the downlink beams are called downlink beam frequency-domain positions, and the frequency-domain positions corresponding to the indexes of the uplink beams are called uplink beam frequency-domain positions, as shown in Table 5.

TABLE 5

| Downlink beam | Frequency-domain position |
|---|---|
| index&uplink beam | where the uplink |
| index--joint beam index | access signal is sent |
| 0&0--0 | Frequency-domain position 0 |
| 0&1--1 | Frequency-domain position 1 |
| . . . | . . . |
| 0&7--7 | Frequency-domain position 7 |
| 1&0--8 | Frequency-domain position 8 |
| 1&1--9 | Frequency-domain position 9 |
| . . . | . . . |
| 1&7--15 | Frequency-domain position 15 |
| . . . | . . . |
| 7&6--62 | Frequency-domain position 62 |
| 7&7--63 | Frequency-domain position 63 |

The terminal detects the downlink signal to obtain an index 1 of an optimal downlink beam, and the terminal selects frequency-domain positions 8˜15 to send the uplink access signals.

The base station detects the uplink access signals at multiple frequency-domain positions, and when the base station detects the uplink access signal with optimal quality at frequency-domain position 14, the base station obtains downlink beam index 1 and uplink beam index 6 corresponding to an optimal uplink beam for the terminal, further obtains an optimal beam for the base station to send downlink data to the terminal according to the index of the downlink beam, and obtains an optimal beam for the terminal to send the uplink data to the base station according to the index of the uplink beam.

### Embodiment 5

It is assumed that a base station sends a downlink synchronization signal and/or downlink system information by virtue of N downlink beams such that an area required to be covered by the base station may substantially be covered. A terminal may send uplink data to the base station by virtue of M uplink beams. N downlink beam indexes and M uplink beam indexes form N*M joint beam indexes. The base station and the terminal preset that N*M uplink access signal sequence sets correspond to the N*M joint beam indexes respectively. Or, the base station notifies a corresponding relationship between the N*M uplink access signal sequence sets and the N*M joint beam indexes respectively to the terminal through a system message. The base station detects uplink access signal sequences to obtain downlink beam indexes and uplink beam indexes corresponding to the terminal. If the terminal wants to obtain the corresponding relationship between the N*M uplink access signal sequence sets and the N*M joint beam indexes respectively through the system message, the terminal is required to receive the system message to obtain the corresponding relationship at first. After obtaining an index of an optimal downlink beam of the base station, the terminal sends an uplink access signal to carry the index of the downlink beam and an index of an uplink beam at a corresponding frequency-domain position. The base station detects the uplink access signal with optimal signal quality sent from the terminal, and obtains the corresponding downlink beam index and uplink beam index according to the frequency-domain position of the uplink access signal.

Sub-Embodiment 1

It is assumed that the base station sends the downlink synchronization signal and/or the downlink system information by virtue of 8 beams, such that the area required to be covered by the base station may substantially be covered. The terminal may transmit the uplink data by virtue of 8 beams. 8 downlink beam indexes and 8 uplink beam indexes form 64 joint beam indexes. The base station and the terminal preset that 64 uplink access signal sequence sets correspond to the 64 joint beam indexes respectively, or the base station notifies the corresponding relationship between the 64 uplink access signal sequence sets and the 64 joint beam indexes to the terminal through a system message, as shown in Table 6. In such case, the set of uplink access signal sequences includes at least one uplink access signal sequence.

TABLE 6

| Downlink beam | Frequency domain position |
|---|---|
| index&uplink beam | where the uplink |
| index--joint beam index | access signal is sent |
| 0&0--0 | Uplink access signal sequence set 0 |
| 0&1--1 | Uplink access signal sequence set 1 |
| . . . | . . . |
| 0&7--7 | Uplink access signal sequence set 7 |
| 1&0--8 | Uplink access signal sequence set 8 |
| 1&1--9 | Uplink access signal sequence set 9 |
| . . . | . . . |
| 1&7--15 | Uplink access signal sequence set 15 |
| . . . | . . . |
| 7&6--62 | Uplink access signal sequence set 62 |
| 7&7--63 | Uplink access signal sequence set 63 |

The terminal detects the downlink signal to obtain an index 1 of an optimal downlink beam, and the terminal selects sequences in uplink access signal sequence sets 8˜15 to send the uplink access signals.

The base station detects the uplink access signals by virtue of multiple uplink access signal sequences, and when the base station detects that a sequence in uplink access signal sequence set 14 is adopted for the uplink access signal with optimal quality, the base station obtains downlink beam index 1 and uplink beam index 6 corresponding to an optimal uplink beam for the terminal, further obtains an optimal beam for the base station to send downlink data to the terminal according to the index of the downlink beam, and obtains an optimal beam for the terminal to send the uplink data to the base station according to the index of the uplink beam.

### Embodiment 6

It is assumed that a base station sends a downlink synchronization signal and/or downlink system information by virtue of N downlink beams such that an area required to be covered by the base station may substantially be covered. A terminal may send uplink data to the base station by virtue of M uplink beams. N downlink beam indexes and M uplink beam indexes form N*M joint beam indexes. The base station and the terminal preset that X*Y=N*M sequence time-domain position sets formed by X uplink access signal sequence sets and Y time-domain positions of uplink access signals correspond to the N*M joint beam indexes respectively. Or, the base station notifies a corresponding relationship between the X*Y=N*M sequence time-domain position sets formed by the X uplink access signal sequence sets and the Y time-domain positions of the uplink access signals and the N*M joint beam indexes to the terminal through a system message. The base station detects sequences and time-domain positions of the uplink access signals to obtain downlink beam indexes and uplink beam indexes corresponding to the terminal. If the terminal wants to obtain the corresponding relationship between the X*Y sequence time-domain position sets and the N*M joint beam indexes through the system message, the terminal is required to receive the system message to obtain the corresponding relationship at first. After obtaining an index of an optimal downlink beam of the base station, the terminal sends an uplink access signal to carry the index of the downlink beam and an index of an uplink beam at the corresponding time-domain position by adopting the corresponding uplink access signal sequence. The base station detects the uplink access signal with optimal signal quality sent from the terminal, and obtains the corresponding downlink beam index and uplink beam index according to the time-domain position of the uplink access signal and the uplink access signal sequence set to which the uplink access signal sequence belongs. In such case, the time-domain positions may include multiple time unit sets. The time-domain positions include occupied time unit indexes and/or duration levels. In such case, the duration levels may be reflected by the numbers of included time units. In such case, the duration levels may also be time-domain repeat levels of the uplink access signals.

Sub-Embodiment 1

It is assumed that the base station sends the downlink synchronization signal and/or the downlink system information by virtue of 8 beams, such that the area required to be covered by the base station may substantially be covered. The terminal may transmit the uplink data by virtue of 8 beams. 8 downlink beam indexes and 8 uplink beam indexes form 64 joint beam indexes. The base station and the terminal preset that 8 time-domain positions where the uplink access signal are sent, and 8 uplink access signal sequence sets form 64 sequence time-domain position sets, and the 64 sequence time-domain position sets correspond to the 64 joint beam indexes respectively. Or the base station notifies a corresponding relationship between the 64 sequence time-domain position sets and the 64 joint beam indexes to the terminal through a system message, as shown in Table 7. The uplink access signal sequence set includes at least one uplink access signal sequence.

TABLE 7

| Downlink beam | |
|---|---|
| index&uplink beam | Sequence time-domain |
| index--joint beam index | position set |
| 0&0--0 | Uplink access signal sequence |
| | time-domain position set 0 |
| 0&1--1 | Uplink access signal sequence |
| | time-domain position set 1 |
| . . . | . . . |
| 0&7--7 | Uplink access signal sequence |
| | time-domain position set 7 |
| 1&0--8 | Uplink access signal sequence |
| | time-domain position set 8 |
| 1&1--9 | Uplink access signal sequence |
| | time-domain position set 9 |
| . . . | . . . |
| 1&7--15 | Uplink access signal sequence |
| | time-domain position set 15 |
| . . . | . . . |
| 7&6--62 | Uplink access signal sequence |
| | time-domain position set 62 |
| 7&7--63 | Uplink access signal sequence |
| | time-domain position set 63 |

The terminal detects the downlink signal to obtain an index 1 of an optimal downlink beam, and the terminal selects the time-domain positions and uplink access signal sequences in uplink access signal sequence time-domain position sets 8˜15 to send the uplink access signals.

The base station detects the uplink access signals at multiple time-domain positions by virtue of multiple uplink access signal sequences, and when the base station detects that the time-domain position and uplink access signal sequence in uplink access signal sequence time-domain position set 14 are adopted for the uplink access signal with optimal quality, the base station obtains downlink beam index 1 and uplink beam index 6 corresponding to an optimal uplink beam for the terminal, further obtains an optimal beam for the base station to send downlink data to the terminal according to the index of the downlink beam, and obtains an optimal beam for the terminal to send the uplink data to the base station according to the index of the uplink beam.

### Embodiment 7

It is assumed that a base station sends a downlink synchronization signal and/or downlink system information by virtue of N downlink beams such that an area required to be covered by the base station may substantially be covered. A terminal may send uplink data to the base station by virtue of M uplink beams. N downlink beam indexes and M uplink beam indexes form N*M joint beam indexes. The base station and the terminal preset that X*Y=N*M sequence frequency-domain position sets formed by X uplink access signal sequence sets and Y frequency-domain positions of uplink access signals correspond to the N*M joint beam indexes respectively. Or, the base station notifies a corresponding relationship between the X*Y=N*M sequence frequency-domain position sets formed by the X uplink access signal sequence sets and the Y frequency-domain positions of the uplink access signals and the N*M joint beam indexes to the terminal through a system message. The base station detects sequences and frequency-domain positions of the uplink access signals to obtain downlink beam indexes and uplink beam indexes corresponding to the terminal. If the terminal wants to obtain the corresponding relationship between the X*Y sequence frequency-domain position sets and the N*M joint beam indexes through the system message, the terminal is required to receive the system message to obtain the corresponding relationship at first. After obtaining an index of an optimal downlink beam of the base station, the terminal sends an uplink access signal to carry the index of the downlink beam and an index of an uplink beam by adopting the corresponding uplink access signal sequence at the corresponding frequency-domain position. The base station detects the uplink access signal with optimal signal quality sent from the terminal, and obtains the corresponding downlink beam index and uplink beam index according to the frequency-domain position of the uplink access signal and the uplink access signal sequence set to which the uplink access signal sequence belongs. In such case, the frequency-domain positions may include multiple starting frequency-domain position and/or bandwidth level sets.

Sub-Embodiment 1

It is assumed that the base station sends the downlink synchronization signal and/or the downlink system information by virtue of 8 beams, such that the area required to be covered by the base station may substantially be covered. The terminal may transmit the uplink data by virtue of 8 beams. 8 downlink beam indexes and 8 uplink beam indexes form 64 joint beam indexes. The base station and the terminal preset that 8 frequency-domain positions where uplink access signal are sent and 8 uplink access signal sequence sets form 64 sequence frequency-domain position sets, and the 64 sequence frequency-domain position sets correspond to the 64 joint beam indexes respectively. Or the base station notifies a corresponding relationship between the 64 sequence frequency-domain position sets and the 64 joint beam indexes to the terminal through a system message, as shown in Table 8. The uplink access signal sequence set includes at least one uplink access signal sequence.

TABLE 8

| Downlink beam | |
|---|---|
| index&uplink beam | Sequence frequency-domain |
| index--joint beam index | position set |
| 0&0--0 | Uplink access signal sequence |
| | frequency-domain position set 0 |
| 0&1--1 | Uplink access signal sequence |
| | frequency-domain position set 1 |
| . . . | . . . |
| 0&7--7 | Uplink access signal sequence |
| | frequency-domain position set 7 |
| 1&0--8 | Uplink access signal sequence |
| | frequency-domain position set 8 |
| 1&1--9 | Uplink access signal sequence |
| | frequency-domain position set 9 |
| . . . | . . . |
| 1&7--15 | Uplink access signal sequence |
| | frequency-domain position set 15 |
| . . . | . . . |
| 7&6--62 | Uplink access signal sequence |
| | frequency-domain position set 62 |
| 7&7--63 | Uplink access signal sequence |
| | frequency-domain position set 63 |

The terminal detects the downlink signal to obtain an index 1 of an optimal downlink beam, and the terminal selects the frequency-domain positions and uplink access signal sequences in uplink access signal sequence frequency-domain position sets 8˜15 to send the uplink access signals.

The base station detects the uplink access signals at multiple frequency-domain positions by virtue of multiple uplink access signal sequences, and when the base station detects that the frequency-domain position and uplink access signal sequence in uplink access signal sequence frequency-domain position set 14 are adopted for the uplink access signal with optimal quality, the base station obtains downlink beam index 1 and uplink beam index 6 corresponding to an optimal uplink beam for the terminal, further obtains an optimal beam for the base station to send downlink data to the terminal according to the index of the downlink beam, and obtains an optimal beam for the terminal to send the uplink data to the base station according to the index of the uplink beam.

### Embodiment 8

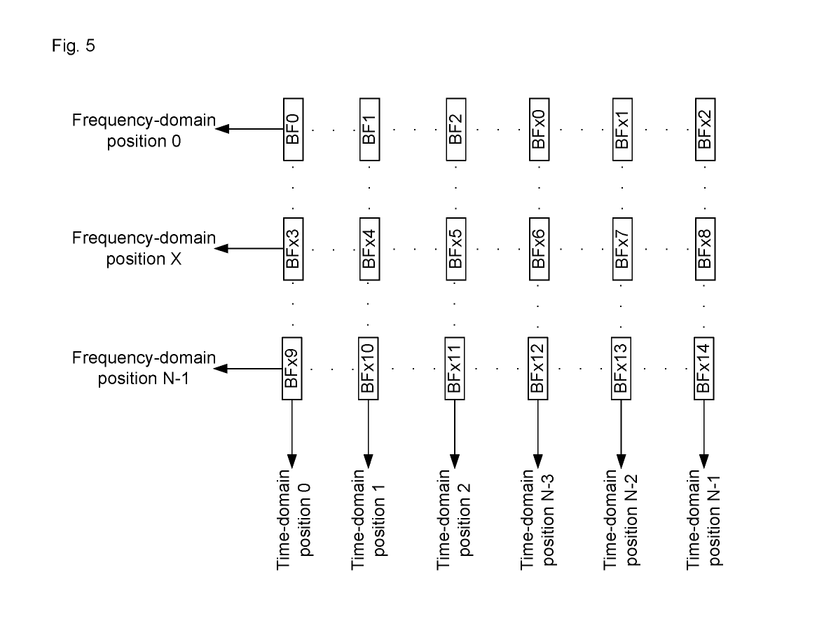

It is assumed that a base station sends a downlink synchronization signal and/or downlink system information by virtue of N downlink beams such that an area required to be covered by the base station may substantially be covered. A terminal may send uplink data to the base station by virtue of M uplink beams. N downlink beam indexes and M uplink beam indexes form N*M joint beam indexes. The base station and the terminal preset that X*Y=N*M time-domain and frequency-domain joint positions formed by X time-domain positions of an uplink access signals and Y frequency-domain positions of the uplink access signals correspond to the N*M joint beam indexes respectively. Or, the base station notifies a corresponding relationship between the X*Y=N*M time-domain and frequency-domain joint positions, which are formed by the X time-domain positions of the uplink access signals and the Y frequency-domain positions of the uplink access signals, and the N*M joint beam indexes to the terminal through a system message. The base station detects the time-domain positions and frequency-domain positions of the uplink access signals to obtain downlink beam indexes and uplink beam indexes corresponding to the terminal. If the terminal wants to obtain the corresponding relationship between the X*Y time-domain and frequency-domain joint positions and the N*M joint beam indexes through the system message, the terminal is required to receive the system message to obtain the corresponding relationship at first. After obtaining an index of an optimal downlink beam of the base station, the terminal sends an uplink access signal to carry the index of the downlink beam and an index of an uplink beam at the corresponding frequency-domain position and time-domain position. The base station detects the uplink access signal with optimal signal quality sent from the terminal, and obtains the corresponding downlink beam index and uplink beam index according to the frequency-domain position and time-domain position of the uplink access signal. As shown in FIG. 5, BFn represents an index of a downlink beam and/or an index of an uplink beam. In such case, the frequency-domain positions may include multiple starting frequency-domain position and/or bandwidth level sets. In such case, the time-domain positions may include multiple time unit sets. The time-domain positions include occupied time unit indexes and/or duration levels. In such case, the duration levels may be reflected by the numbers of included time units. In such case, the duration levels may also be time-domain repeat levels of the uplink access signals.

Sub-Embodiment 1

It is assumed that the base station sends the downlink synchronization signal and/or the downlink system information by virtue of 8 beams, such that the area required to be covered by the base station may substantially be covered. The terminal may transmit the uplink data by virtue of 8 beams. 8 downlink beam indexes and 8 uplink beam indexes form 64 joint beam indexes. The base station and the terminal preset that 8 frequency-domain positions where uplink access signal are sent and 8 time-domain positions where uplink access signal are sent form 64 time-domain and frequency-domain joint positions, and the 64 time-domain and frequency-domain joint positions correspond to the 64 joint beam indexes respectively. Or the base station notifies a corresponding relationship between the 64 time-domain and frequency-domain joint positions and the 64 joint beam indexes to the terminal through a system message, as shown in Table 9. The uplink access signal sequence set includes at least one uplink access signal sequence.

TABLE 9

| Downlink beam | |
|---|---|
| index&uplink beam | Time-domain and frequency-domain |
| index--joint beam index | joint position |
| 0&0--0 | Time-domain and frequency-domain joint |
| | position 0 |
| 0&1--1 | Time-domain and frequency-domain joint |
| | position 1 |
| . . . | . . . |
| 0&7--7 | Time-domain and frequency-domain joint |
| | position 7 |
| 1&0--8 | Time-domain and frequency-domain joint |
| | position 8 |
| 1&1--9 | Time-domain and frequency-domain joint |
| | position 9 |
| . . . | . . . |
| 1&7--15 | Time-domain and frequency-domain joint |
| | position 15 |
| . . . | . . . |
| 7&6--62 | Time-domain and frequency-domain joint |
| | position 62 |
| 7&7--63 | Time-domain and frequency-domain joint |
| | position 63 |

The terminal detects the downlink signal to obtain an index 1 of an optimal downlink beam, and the terminal selects the frequency-domain positions of the uplink access signal and the time-domain positions of the uplink access signal in uplink access signal time-domain and frequency-domain joint positions 8˜15 to send the uplink access signals.

The base station detects the uplink access signals at multiple time-domain positions and frequency-domain positions, and when the base station detects the uplink access signal with optimal quality at the frequency-domain position and time-domain position in uplink access signal time-domain and frequency-domain joint position 14, the base station obtains downlink beam index 1 and uplink beam index 6 corresponding to an optimal uplink beam for the terminal, further obtains an optimal beam for the base station to send downlink data to the terminal according to the index of the downlink beam, and obtains an optimal beam for the terminal to send the uplink data to the base station according to the index of the uplink beam.

### Embodiment 9

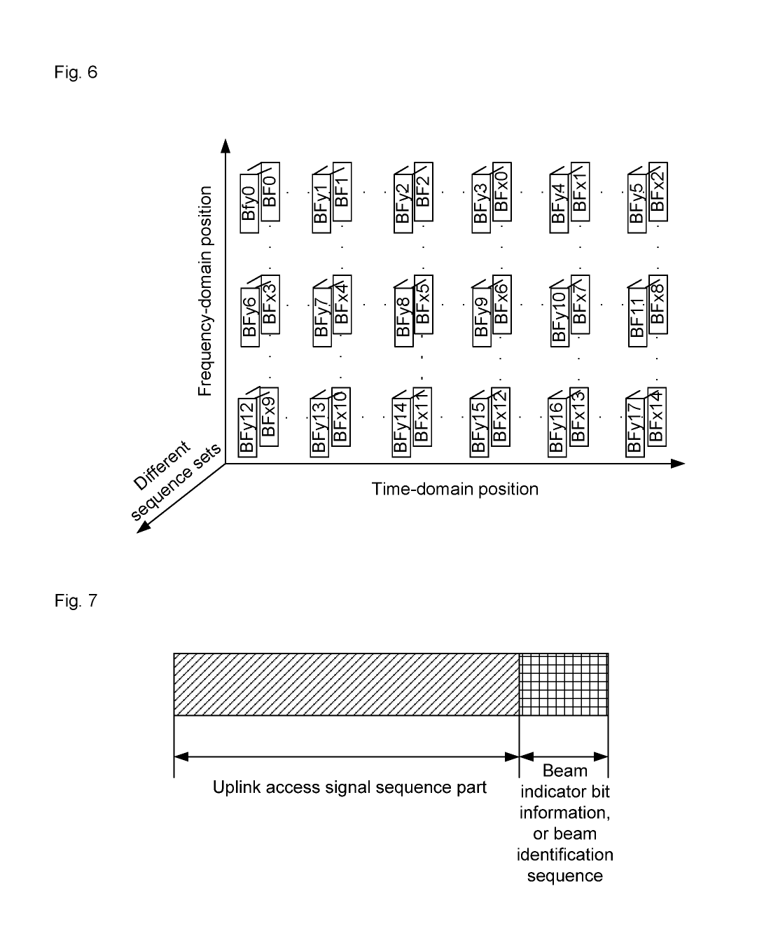

It is assumed that a base station sends a downlink synchronization signal and/or downlink system information by virtue of N downlink beams such that an area required to be covered by the base station may substantially be covered. A terminal may send uplink data to the base station by virtue of M uplink beams. N downlink beam indexes and M uplink beam indexes form N*M joint beam indexes. The base station and the terminal preset that X*Y*Z=N*M sequence and time-domain and frequency-domain joint position sets, which are formed by X time-domain positions of uplink access signals, Y frequency-domain positions of the uplink access signals and Z uplink access signal sequence sets, correspond to the N*M joint beam indexes respectively. Or, the base station notifies a corresponding relationship between the X*Y*Z=N*M sequence and time-domain and frequency-domain joint position sets, which are formed by the X time-domain positions of the uplink access signals, the Y frequency-domain positions of the uplink access signals and the Z uplink access signal sequence sets, and the N*M joint beam indexes to the terminal through a system message. The base station detects the time-domain positions and frequency-domain positions of the uplink access signals and the uplink access signal sequence sets, to which the sequences of the uplink access signals belong, to obtain corresponding downlink beam indexes fed back by the terminal and corresponding uplink beam indexes used by the terminal. If the terminal wants to obtain the corresponding relationship between the X*Y*Z=N*M sequence and time-domain and frequency-domain joint position sets formed by the X time-domain positions of the uplink access signals, the Y frequency-domain positions of the uplink access signals and the Z uplink access signal sequence sets and the N*M joint beam indexes through the system message, the terminal is required to receive the system message to obtain the corresponding relationship at first. After obtaining an index of an optimal downlink beam of the base station, the terminal sends an uplink access signal to carry the index of the downlink beam and an index of an uplink beam at the corresponding frequency-domain position and time-domain position by virtue of the sequence in the corresponding uplink access signal sequence set. The base station detects the uplink access signal with optimal signal quality sent from the terminal, and obtains the corresponding downlink beam index and uplink beam index according to the frequency-domain position, time-domain position and sequence of the uplink access signal. As shown in FIG. 6, BFn represents an index of a downlink beam and/or an index of an uplink beam. The frequency-domain positions may include multiple starting frequency-domain position and/or bandwidth level sets; and the time-domain positions may include multiple time unit sets. The time-domain positions include occupied time unit indexes and/or duration levels. In such case, the duration levels may be reflected by the numbers of included time units. In such case, the duration levels may also be time-domain repeat levels of the uplink access signals.

Sub-Embodiment 1

It is assumed that the base station sends the downlink synchronization signal and/or the downlink system information by virtue of 8 beams, such that the area required to be covered by the base station may substantially be covered. The terminal may transmit the uplink data by virtue of 8 beams. 8 downlink beam indexes and 8 uplink beam indexes form 64 joint beam indexes. The base station and the terminal preset that 2 frequency-domain positions where uplink access signal are sent, 2 time-domain positions where uplink access signal are sent and 16 uplink access signal sequence sets form 64 sequence and time-domain and frequency-domain joint position sets and the 64 sequence and time-domain and frequency-domain joint position sets correspond to the 64 joint beam indexes respectively. Or the base station notifies a corresponding relationship between the 64 sequence and time-domain and frequency-domain joint position sets and the 64 joint beam indexes to the terminal through a system message, as shown in Table 10. The uplink access signal sequence set includes at least one uplink access signal sequence.

TABLE 10

| Downlink beam | Sequence and time-domain |
|---|---|
| index&uplink beam | and frequency-domain |
| index--joint beam index | joint position set |
| 0&0--0 | Sequence and time-domain and |
| | frequency-domain joint position set 0 |
| 0&1--1 | Sequence and time-domain and |
| | frequency-domain joint position set 1 |
| . . . | . . . |
| 0&7--7 | Sequence and time-domain and |
| | frequency-domain joint position set 7 |
| 1&0--8 | Sequence and time-domain and |
| | frequency-domain joint position set 8 |
| 1&1--9 | Sequence and time-domain and |
| | frequency-domain joint position set 9 |
| . . . | . . . |
| 1&7--15 | Sequence and time-domain and |
| | frequency-domain joint position set 15 |
| . . . | . . . |
| 7&6--62 | Sequence and time-domain and |
| | frequency-domain joint position set 62 |
| 7&7--63 | Sequence and time-domain and |
| | frequency-domain joint position set 63 |

The terminal detects the downlink signal to obtain an index 1 of an optimal downlink beam, and the terminal selects the frequency-domain positions of the uplink access signal, the time-domain positions of the uplink access signal and sequences in uplink access signal sequence sets in uplink access signal sequence and time-domain and frequency-domain joint position sets 8˜15 to send the uplink access signals.

The base station detects the uplink access signals at multiple time-domain positions and frequency-domain positions, and when the base station detects that the frequency-domain position, time-domain position and uplink access signal sequence in uplink access signal sequence and time-domain and frequency-domain joint position set 14 are adopted for the uplink access signal with optimal quality, the base station obtains downlink beam index 1 and uplink beam index 6 corresponding to an optimal uplink beam for the terminal, further obtains an optimal beam for the base station to send downlink data to the terminal according to the index of the downlink beam, and obtains an optimal beam for the terminal to send the uplink data to the base station according to the index of the uplink beam.

The embodiment of the disclosure may also include that the indexes of the uplink beams and the indexes of the downlink beams correspond to different characteristics of uplink access signals. For example: the indexes of the uplink beams correspond to the time-domain positions, and the indexes of the downlink beams correspond to the frequency-domain positions; or, the indexes of the uplink beams correspond to the frequency-domain positions, and the indexes of the downlink beams correspond to the time-domain positions; or, the indexes of the uplink beams correspond to the uplink access signal sequence sets, and the indexes of the downlink beams correspond to the time-domain positions; or, the indexes of the uplink beams correspond to the time-domain positions, and the indexes of the downlink beams correspond to the uplink access signal sequence sets; or, the indexes of the uplink beams correspond to the frequency-domain positions, and the indexes of the downlink beams correspond to the uplink access signal sequence sets; or, the indexes of the uplink beams correspond to the uplink access signal sequence sets, and the indexes of the downlink beams correspond to the frequency-domain positions; or the like.

### Embodiment 10

It is assumed that a base station sends a downlink synchronization signal and/or downlink system information by virtue of N beams such that an area required to be covered by the base station may substantially be covered. The base station and a terminal preset uplink access signal sequence sets, time-domain positions and frequency-domain positions, or, the base station notifies the uplink access signal sequence sets, the time-domain positions and the frequency-domain positions to the terminal through a system message. In addition, the terminal is required to carry information bits or beam identification sequences of downlink beam indexes after access signals. For example, the terminal sends information bits carrying the indexes of the downlink beams and/or uplink beam indexes in the time domain and/or the frequency domain after sending the access signals. Or, the terminal sends beam identification sequences carrying the indexes of the downlink beams and/or the indexes of the uplink beams in the time domain and/or the frequency domain after sending the access signals, and different beam identification sequence sets may correspond to different downlink beam indexes and/or uplink beam indexes, as shown in FIG. 7. Each beam identification sequence set includes at least one sequence. In such case, a corresponding relationship between the beam identification sequence sets and the indexes of the downlink beams may be determined in a manner of presetting, or may be notified to the terminal by the base station through the system message. Downlink beams may be indicated by virtue of the time-domain positions and/or frequency-domain positions and/or sequences of the uplink access signals, and the indexes of the uplink beams may be indicated by virtue of additional bit information or beam identification sequences. Or, uplink beams may be indicated by virtue of the time-domain positions and/or frequency-domain positions and/or sequences of the uplink access signals, and the indexes of the downlink beams may be indicated by virtue of the additional bit information or beam identification sequences.

### Embodiment 11

It is assumed that a base station sends a downlink synchronization signal and/or downlink system information by virtue of N downlink beams such that an area required to be covered by the base station may substantially be covered. The base station and a terminal preset that N time-domain positions correspond to N downlink beam indexes respectively. Or, the base station notifies a corresponding relationship between the N time-domain positions and the N downlink beam indexes respectively to the terminal through a system message. The base station may detect the time-domain positions of uplink access signals of the terminal at one or more time-domain positions to obtain corresponding downlink beam indexes fed back by the terminal. If the terminal wants to obtain the corresponding relationship between the N time-domain positions and the N downlink beam indexes respectively through the system message, the terminal is required to receive the system message to obtain the corresponding relationship at first. After obtaining related information of an optimal beam index of the base station, the terminal sends an uplink access signal to indirectly feed back an index of a downlink beam at the corresponding time-domain position, for example, as shown in FIG. 3. In such case, the time-domain positions may include sets of multiple time units. The time units may be micro-frames, sub-frames, half frames, radio frames or the like. When sending the uplink access signal, the terminal is required to perform beamforming on the uplink access signal, namely to send the uplink access signal by adopting an uplink beam, to ensure coverage, the terminal selects a subset of time units or duration from the time-domain position, configured by the base station, corresponding to the index of the downlink beam to identify the uplink beam of the uplink access signal, the base station is not required to know a relationship between the index of the uplink beam and the subset, the base station only feeds back a corresponding time-domain position subset index or gives a random access response at the corresponding time-domain position, and the terminal may determine an index of an optimal uplink beam fed back by the base station according to the corresponding time-domain position subset index fed back by the base station or time when the random access response is received, thereby obtaining an optimal uplink beam from the terminal to the base station according to the index of the uplink beam.

Sub-Embodiment 1

It is assumed that the base station sends the downlink synchronization signal and/or the downlink system information by virtue of 8 downlink beams such that the area required to be covered by the base station may substantially be covered. The base station and the terminal preset that 8 time-domain positions correspond to 8 downlink beam indexes respectively, or the base station notifies a corresponding relationship between the 8 time-domain positions and the 8 downlink beam indexes to the terminal through a system message, as shown in Table 11. In such case, the time-domain positions may include occupied time unit indexes and/or durations. In such case, the durations may be reflected by the numbers of included time units. In such case, the durations may also be time-domain repeat frequencies of uplink access signals.

TABLE 11

| | Time-domain position |
|---|---|
| | where the uplink |
| Downlink beam index | access signal is sent |
| 0 | Time-domain position 0 |
| 1 | Time-domain position 1 |
| 2 | Time-domain position 2 |
| 3 | Time-domain position 3 |
| 4 | Time-domain position 4 |
| 5 | Time-domain position 5 |
| 6 | Time-domain position 6 |
| 7 | Time-domain position 7 |

If the terminal detects the downlink signal to obtain optimal downlink beam index 6, the terminal selects time-domain position 6 to send the uplink access signal.

The base station detects the uplink access signals at multiple time-domain positions, and when the base station detects the uplink access signal at time-domain position 6, the base station obtains an index of a downlink beam fed back by the terminal, and the base station further obtains an optimal beam for sending downlink data to the terminal according to the fed-back downlink beam index. Then the base station may subsequently adopt the optimal beam to transmit the data to the terminal.

If the terminal may send the uplink access signal by virtue of 4 uplink beams, time-domain position 6 includes: a time unit set {8n, 8n+2, 8n+4, 8n+6}, wherein n>−1 and n is an integer. The terminal sends the uplink access signal by virtue of an uplink beam corresponding to uplink beam index 0 on time unit 8n, the terminal sends the uplink access signal by virtue of an uplink beam corresponding to uplink beam index 1 on time unit 8n+2, the terminal sends the uplink access signal by virtue of an uplink beam corresponding to uplink beam index 2 on time unit 8n+4, and the terminal sends the uplink access signal by virtue of an uplink beam corresponding to uplink beam index 3 by virtue of time unit 8n+6.

The base station detects the uplink access signal with optimal signal quality, and directly or indirectly feeds back related information of the time unit, where the uplink access signal is located, in a downlink access response, and the terminal may obtain the corresponding optimal uplink beam from the terminal to the base station by obtaining the related information, fed back by the base station, of the time unit.

### Embodiment 12

It is assumed that a base station sends a downlink synchronization signal and/or downlink system information by virtue of N downlink beams such that an area required to be covered by the base station may substantially be covered. The base station and a terminal preset that N frequency-domain positions correspond to N downlink beam indexes respectively. Or, the base station notifies a corresponding relationship between the N frequency-domain positions and the N downlink beam indexes to the terminal through a system message. The base station may detect the frequency-domain positions of uplink access signals of the terminal at one or more frequency-domain positions to obtain corresponding downlink beam indexes fed back by the terminal. If the terminal wants to obtain the corresponding relationship between the N frequency-domain positions and the N downlink beam indexes through the system message, the terminal is required to receive the system message to obtain the corresponding relationship at first. After obtaining related information of an optimal beam index of the base station, the terminal sends an uplink access signal to indirectly feed back the index of the downlink beam at the corresponding frequency-domain position, for example. As shown in FIG. 4, the frequency-domain positions may include sets of multiple starting frequency-domain positions and/or bandwidths. When sending the uplink access signal, the terminal is required to perform beamforming on the uplink access signal, namely to send the uplink access signal by adopting an uplink beam, to ensure coverage, the terminal selects a subset of frequency-domain positions and/or bandwidths from the frequency-domain position, configured by the base station, corresponding to the index of the downlink beam to identify the uplink beam of the uplink access signal, the base station is not required to know a relationship between the index of the uplink beam and the subset, the base station only feeds back a corresponding frequency-domain position subset index or gives a random access response at the corresponding frequency-domain position, and the terminal may determine an index of an optimal uplink beam fed back by the base station according to the corresponding frequency-domain position subset index fed back by the base station or time when the random access response is received, thereby obtaining an optimal uplink beam from the terminal to the base station according to the index of the uplink beam.

Sub-Embodiment 1

It is assumed that the base station sends the downlink synchronization signal and/or the downlink system information by virtue of 8 downlink beams such that the area required to be covered by the base station may substantially be covered. The base station and the terminal preset that 8 frequency-domain positions correspond to 8 downlink beam indexes respectively, or the base station notifies a corresponding relationship between the 8 frequency-domain positions and the 8 downlink beam indexes to the terminal through a system message, as shown in Table 12. In such case, the frequency-domain positions may include occupied time unit indexes and/or durations. In such case, the durations may be reflected by the numbers of included time units. The durations may also be frequency-domain repeat frequencies of uplink access signals.

TABLE 12

| | Frequency-domain position |
|---|---|
| | where the uplink |
| Downlink beam index | access signal is sent |
| 0 | Frequency-domain position 0 |
| 1 | Frequency-domain position 1 |
| 2 | Frequency-domain position 2 |
| 3 | Frequency-domain position 3 |
| 4 | Frequency-domain position 4 |
| 5 | Frequency-domain position 5 |
| 6 | Frequency-domain position 6 |
| 7 | Frequency-domain position 7 |

If the terminal detects the downlink signal to obtain optimal downlink beam index 6, the terminal selects frequency-domain position 6 to send the uplink access signal.

The base station detects the uplink access signals at multiple frequency-domain positions, and when the base station detects the uplink access signal at frequency-domain position 6, the base station obtains an index of a downlink beam fed back by the terminal, and further obtains an optimal beam for the base station to send downlink data to the terminal according to the fed-back downlink beam index. Then the base station may subsequently adopt the optimal beam to transmit the data to the terminal.

If the terminal may send the uplink access signal by virtue of 4 uplink beams, frequency-domain position 6 includes: a starting frequency-domain position and/or bandwidth set unit index {8n, 8n+2, 8n+4, 8n+6}, wherein n>−1 and n is an integer. The terminal sends the uplink access signal by virtue of an uplink beam corresponding to uplink beam index 0 at a starting frequency-domain position and/or bandwidth corresponding to starting frequency-domain position and/or bandwidth set unit index 8n; the terminal sends the uplink access signal by virtue of an uplink beam corresponding to uplink beam index 1 at a starting frequency-domain position and/or bandwidth corresponding to starting frequency-domain position and/or bandwidth set unit index 8n+2; the terminal sends the uplink access signal by virtue of an uplink beam corresponding to uplink beam index 2 at a starting frequency-domain position and/or bandwidth corresponding to starting frequency-domain position and/or bandwidth set unit index 8n+4; and the terminal sends the uplink access signal by virtue of an uplink beam corresponding to uplink beam index 3 at a starting frequency-domain position and/or bandwidth corresponding to starting frequency-domain position and/or bandwidth set unit index 8n+6.

The base station detects the uplink access signal with optimal signal quality, and directly or indirectly feeds back related information of the starting frequency-domain position and/or bandwidth unit index of the uplink access signal in a downlink access response, and the terminal further obtains the corresponding optimal uplink beam from the terminal to the base station after obtaining the related information, fed back by the base station, of the starting frequency-domain position and/or bandwidth unit index.

### Embodiment 13

It is assumed that a base station sends a downlink synchronization signal and/or downlink system information by virtue of N downlink beams such that an area required to be covered by the base station may substantially be covered. The base station and a terminal preset that N uplink access signal sequence sets correspond to N downlink beam indexes respectively. Or, the base station notifies a corresponding relationship between the N uplink access signal sequence sets and the N downlink beam indexes to the terminal through a system message. The base station may detect the uplink access signal sequence sets where uplink access signals of the terminal are located to obtain corresponding downlink beam indexes fed back by the terminal. If the terminal wants to obtain the corresponding relationship between the N uplink access signal sequence sets and the N downlink beam indexes through the system message, the terminal is required to receive the system message to obtain the corresponding relationship at first. After obtaining related information of an optimal beam index of the base station, the terminal sends an uplink access signal to indirectly feed back the index of the downlink beam by virtue of a sequence in the corresponding uplink access signal sequence set. When sending the uplink access signal, the terminal is required to perform beamforming on the uplink access signal, namely to send the uplink access signal by adopting an uplink beam, to ensure coverage, the terminal selects a sequence adopted for an uplink access signal in a subset from the uplink access signal sequence set, configured by the base station, corresponding to the index of the downlink beam to identify the uplink beam of the uplink access signal, the base station is not required to know a relationship between the index of the uplink beam and the sequence of the subset, the base station only directly or indirectly an index of the sequence of the subset in an access response, and the terminal may determine an index of an optimal uplink beam fed back by the base station according to the corresponding index of the sequence of the subset fed back by the base station, thereby obtaining an optimal uplink beam from the terminal to the base station according to the index of the uplink beam.

Sub-Embodiment 1

It is assumed that the base station sends the synchronization signal and/or the downlink system information by virtue of 8 downlink beams such that the area required to be covered by the base station may substantially be covered. The base station and the terminal preset that 8 uplink access signal sequence sets correspond to 8 downlink beam indexes respectively, or the base station notifies a corresponding relationship between the 8 uplink access signal sequence sets and the 8 downlink beam indexes respectively to the terminal through a system message, as shown in Table 13.

TABLE 13

| Downlink beam index | Uplink access signal sequence set |
|---|---|
| 0 | Uplink access signal sequence set 0 |
| 1 | Uplink access signal sequence set 1 |
| 2 | Uplink access signal sequence set 2 |
| 3 | Uplink access signal sequence set 3 |
| 4 | Uplink access signal sequence set 4 |
| 5 | Uplink access signal sequence set 5 |
| 6 | Uplink access signal sequence set 6 |
| 7 | Uplink access signal sequence set 7 |

If the terminal detects the downlink signal to obtain an index 6 of an optimal downlink beam, the terminal selects an uplink access signal sequence in uplink access signal sequence set 6 to send the uplink access signal.

The base station detects the uplink access signals, and when the base station detects that the uplink access signal sequence with optimal signal quality comes from uplink access signal sequence set 6, the base station obtains downlink beam index 6 fed back by the terminal, and further obtains an optimal beam for the base station to send downlink data to the terminal according to the fed-back downlink beam index. Then the base station may subsequently adopt the optimal beam to transmit the data to the terminal.

If the terminal may send the uplink access signal by virtue of 4 uplink beams, uplink access signal sequence set 6 includes: uplink access signal sequence subsets 0˜3. The terminal sends uplink access signal 0 by virtue of a sequence in uplink access signal sequence subset 0 and uplink beam 0. The terminal sends uplink access signal 1 by virtue of a sequence in uplink access signal sequence subset 1 and uplink beam 1. The terminal sends uplink access signal 2 by virtue of a sequence in uplink access signal sequence subset 2 and uplink beam 2. The terminal sends uplink access signal 3 by virtue of a sequence in uplink access signal sequence subset 3 and uplink beam 3.

The base station detects the uplink access signal with optimal signal quality, and directly or indirectly feeds back related information of a sequence subset index of the uplink access signal in a downlink access response, and the terminal may further obtain the corresponding optimal uplink beam from the terminal to the base station by obtaining the related information, fed back by the base station, of the sequence subset index.

### Embodiment 14

It is assumed that a base station sends a downlink synchronization signal and/or downlink system information by virtue of N downlink beams such that an area required to be covered by the base station may substantially be covered. The base station and a terminal preset that N uplink access signal sequence sets correspond to N downlink beam indexes respectively. Or, the base station notifies a corresponding relationship between the N uplink access signal sequence sets and the N downlink beam indexes to the terminal through a system message. The base station detects uplink access signal sequence sets where uplink access signals of the terminal are located to obtain corresponding downlink beam indexes fed back by the terminal. If the terminal wants to obtain the corresponding relationship between the N uplink access signal sequence sets and the N downlink beam indexes through the system message, the terminal is required to receive the system message to obtain the corresponding relationship at first. After obtaining related information of an optimal beam index of the base station, the terminal sends an uplink access signal to indirectly feed back the index of the downlink beam by virtue of a sequence in the corresponding uplink access signal sequence set. When sending the uplink access signal, the terminal is required to perform beamforming on the uplink access signal, namely to send the uplink access signal by adopting an uplink beam, to ensure coverage, the terminal sends the uplink access signal at a time-domain position and/or frequency-domain position, which are/is configured by the base station or preset, by virtue of the uplink access signal sequence corresponding to the downlink beam, and the terminal identifies different uplink beams by virtue of different time-domain and/or frequency-domain positions. The base station is not required to know a relationship between the uplink beam and the time-domain position and/or the frequency-domain position. The base station only directly or indirectly feeds back related information of a corresponding time-domain and/or frequency-domain position index in an access response, and the terminal may determine an index of an optimal uplink beam fed back by the base station according to the related information of the corresponding time-domain position and/or frequency-domain position fed back by the base station, thereby obtaining an optimal uplink beam from the terminal to the base station according to the index of the uplink beam.

### Embodiment 15

It is assumed that a base station sends a downlink synchronization signal and/or downlink system information by virtue of N downlink beams such that an area required to be covered by the base station may substantially be covered. The base station and a terminal preset that N uplink access signal time-domain positions correspond to N downlink beam indexes respectively. Or, the base station notifies a corresponding relationship between the N uplink access signal time-domain positions and the N downlink beam indexes to the terminal through a system message. The base station detects time-domain positions where uplink access signal sequences of the terminal are located to obtain corresponding downlink beam indexes fed back by the terminal. If the terminal wants to obtain the corresponding relationship between the N uplink access signal time-domain positions and the N downlink beam indexes through the system message, the terminal is required to receive the system message to obtain the corresponding relationship at first. After obtaining related information of an optimal beam index of the base station, the terminal sends an uplink access signal to indirectly feed back the index of the downlink beam at the corresponding uplink access signal time-domain position. When sending the uplink access signal, the terminal is required to perform beamforming on the uplink access signal, namely to send the uplink access signal by adopting an uplink beam, to ensure coverage, the terminal sends the uplink access signal at a frequency-domain position, which is configured by the base station or preset, by virtue of a sequence in an uplink access signal sequence set which is configured by the base station or preset, and the terminal identifies different uplink beams by virtue of different frequency-domain positions and/or uplink access signal sequences. The base station is not required to know a relationship between the frequency-domain position and/or the uplink access signal sequence and the uplink beam. The base station only directly or indirectly feeds back related information of the corresponding frequency-domain position and/or uplink access signal sequence index in an access response, and the terminal may determine an index of an optimal uplink beam fed back by the base station according to the related information of the corresponding frequency-domain position and/or uplink access signal sequence fed back by the base station, thereby obtaining an optimal uplink beam from the terminal to the base station according to the index of the uplink beam.

### Embodiment 16

It is assumed that a base station sends a downlink synchronization signal and/or downlink system information by virtue of N downlink beams such that an area required to be covered by the base station may substantially be covered. The base station and a terminal preset that N uplink access signal frequency-domain positions correspond to N downlink beam indexes respectively. Or, the base station notifies a corresponding relationship between the N uplink access signal frequency-domain positions and the N downlink beam indexes to the terminal through a system message. The base station detects frequency-domain positions where uplink access signal sequences of the terminal are located to obtain corresponding downlink beam indexes fed back by the terminal. If the terminal wants to obtain the corresponding relationship between the N uplink access signal frequency-domain positions and the N downlink beam indexes respectively through the system message, the terminal is required to receive the system message to obtain the corresponding relationship at first. After obtaining related information of an optimal beam index of the base station, the terminal sends an uplink access signal to indirectly feed back the index of the downlink beam at the corresponding uplink access signal frequency-domain position. When sending the uplink access signal, the terminal is required to perform beamforming on the uplink access signal, namely to send the uplink access signal by adopting an uplink beam, to ensure coverage, the terminal sends the uplink access signal at a frequency-domain position, which is configured by the base station or preset, by virtue of a sequence in an uplink access signal sequence set which is configured by the base station or preset, and the terminal identifies different uplink beams by virtue of different time-domain positions and/or uplink access signal sequences. The base station is not required to know a relationship between the time-domain position and/or the uplink access signal sequence and the uplink beam. The base station only directly or indirectly feeds back related information of the corresponding time-domain position and/or uplink access signal sequence index in an access response, and the terminal may determine an index of an optimal uplink beam fed back by the base station according to the related information of the corresponding time-domain position and/or uplink access signal sequence fed back by the base station, thereby obtaining an optimal uplink beam from the terminal to the base station according to the index of the uplink beam.

Considering that different uplink beams of the terminal may have different sending power, the base station may configure that the terminal adopt different sending power for different beams to enable the terminal to fulfil the aim of meeting a signal quality requirement by virtue of beams with lower power.

In the disclosure, feedback of the beam index includes feedback of an index of an optimal uplink beam, feedback of an index of an optimal downlink beam, feedback of multiple indexes of optimal uplink beams and feedback of multiple indexes of optimal downlink beams.

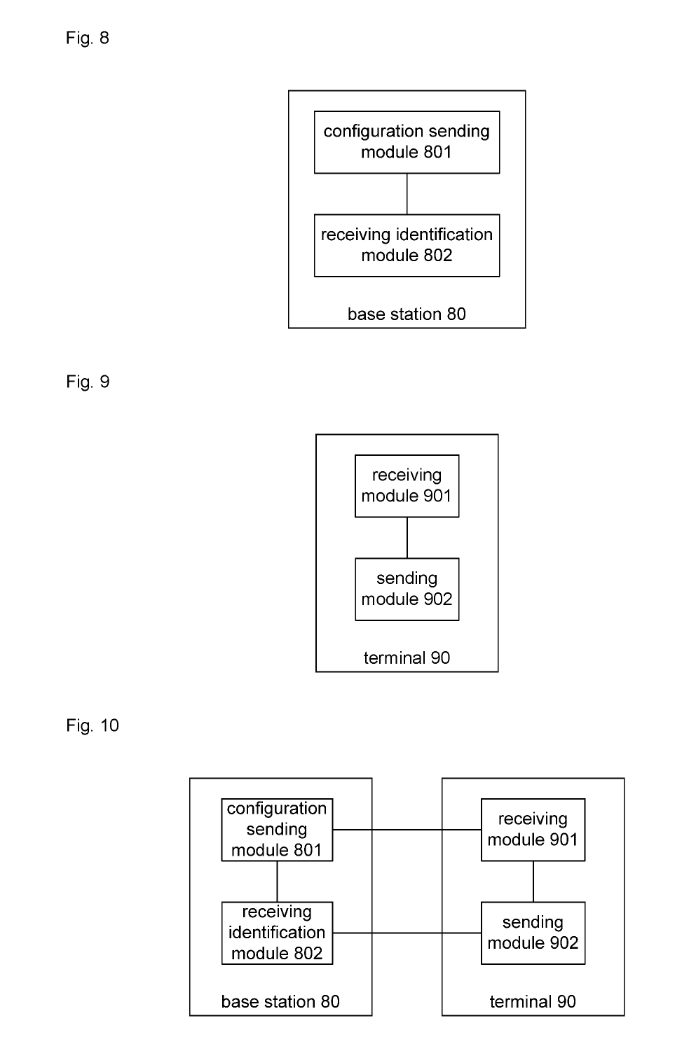

The embodiment of the disclosure further provides a base station, and as shown in FIG. 8, the base station 80 includes: a configuration sending module 801 and a receiving identification module 802.

The configuration sending module 801 may be implemented by a transmitter of the base station, and is configured to notify a corresponding relationship between a characteristic of an uplink access signal and an index of an uplink beam and/or an index of a downlink beam in a manner of presetting and/or a manner of system message configuration, the characteristic of the uplink access signal is used for indicating the index of the uplink beam for sending the uplink access signal, and/or the index of the downlink beam.

The receiving identification module 802 may be implemented by a receiver of the base station, and is configured to identify the characteristic of the uplink access signal to obtain the index of the uplink beam and/or the index of the downlink beam after receiving the uplink access signal.

In such case, the characteristic of the uplink access signal includes at least one of: a time-domain position of the uplink access signal, a frequency-domain position of the uplink access signal, a set of sequences adopted for the uplink access signals, bit information for indicating index carried after the uplink access signal and a beam identification sequence carried after the uplink access signal.

In such case, the operation that the receiving identification module 802 identifies the index of the uplink beam and/or the index of the downlink beam includes at least one of that:

the receiving identification module 802 performs identification through the time-domain position of the received uplink access signal;

the receiving identification module 802 performs identification through the frequency-domain position of the received uplink access signal;

the receiving identification module 802 performs identification through the set of sequences adopted for the received uplink access signals;

the receiving identification module 802 performs identification through the bit information for indicating index carried after the received uplink access signal; and

the receiving identification module 802 performs identification through the beam identification sequence carried after the received uplink access signal.

Preferably, when the receiving identification module 802 identifies the index of the uplink beam and/or the index of the downlink beam through the time-domain position, the configuration sending module 801 is further configured to add a corresponding relationship between the time-domain position and the index of the uplink beam and/or the index of the downlink beam into a system message when configuring the system message.

Preferably, when the receiving identification module 802 identifies the index of the uplink beam and/or the index of the downlink beam through the frequency-domain position, the configuration sending module 801 is further configured to add a corresponding relationship between the frequency-domain position and the index of the uplink beam and/or the index of the downlink beam into the system message when configuring the system message.

Preferably, when the receiving identification module 802 identifies the index of the uplink beam and/or the index of the downlink beam through a sequence adopted for an uplink access signal, the configuration sending module 801 is further configured to add a corresponding relationship between the set of sequences adopted for the uplink access signals and the index of the uplink beam and/or the index of the downlink beam into the system message when configuring the system message.

The embodiment of the disclosure further provides a terminal, and as shown in FIG. 9, the terminal 90 includes: a receiving module 901 and a sending module 902.

The receiving module 901 may be implemented by a receiver of the terminal, and is configured to obtain a corresponding relationship between a characteristic of the uplink access signal and an index of an uplink beam and/or an index of a downlink beam in a manner of presetting and/or a received manner of system message configuration.

The sending module 902 may be implemented by a transmitter of the terminal, and is configured to send the uplink access signal, the characteristic of the uplink access signal is used for indicating the index of the uplink beam corresponding to an uplink beam for the terminal to send the uplink access signal, and/or the index of the downlink beam to be fed back.

Preferably, the receiving module 901 is further configured to obtain a beam indication manner in a manner of presetting or a received system message configuration.

In such case, the characteristic of the uplink access signal includes at least one of: a time-domain position of the uplink access signal, a frequency-domain position of the uplink access signal, a set of sequences adopted for the uplink access signals, bit information for indicating index carried after the uplink access signal and a beam identification sequence carried after the uplink access signal.

In such case, the operation that the sending module 902 indicates the index of the uplink beam and/or the index of the downlink beam includes at least one of:

sending the uplink access signal at a preset time-domain position;

sending the uplink access signal at a preset frequency-domain position;

selecting a corresponding sequence from a preset set of sequences to send the uplink access signal according to the sequence set;

carrying the bit information indicating the index of the uplink beam and/or the index of the downlink beam when sending the uplink access signal; and

carrying the beam identification sequence for indicating the index of the uplink beam and/or the index of the downlink beam when sending the uplink access signal.

Preferably, when the sending module 902 indicates the index of the uplink beam and/or the index of the downlink beam by virtue of the time-domain position where the uplink access signal is sent, the receiving module is further configured to obtain a corresponding relationship between the time-domain position and the index of the uplink beam and/or the index of the downlink beam from a system message after receiving the system message.

Preferably, when the sending module 902 indicates the index of the uplink beam and/or the index of the downlink beam by virtue of the frequency-domain position where the uplink access signal is sent,

the receiving module is further configured to obtain a corresponding relationship between the frequency-domain position and the index of the uplink beam and/or the index of the downlink beam from the system message after receiving the system message.

Preferably, when the sending module 902 indicates the index of the uplink beam and/or the index of the downlink beam by virtue of a sequence adopted for an uplink access signal,

the receiving module is further configured to obtain a corresponding relationship between the sequence set adopted for the uplink access signal and the index of the uplink beam and/or the index of the downlink beam from the system message after receiving the system message.

The embodiment of the disclosure further provides a system for mixedly indicating uplink and downlink beams, and as shown in FIG. 10, the system includes the abovementioned base station 80 and terminal 90.

Preferably, the configuration sending module 801 in the base station 80 is further configured to set a beam identification manner consistent with that adopted by the terminal in the manner of presetting or in the manner of system message configuration.

Preferably, the configuration sending module 801 in the base station 80 is further configured to notify a beam indication manner to be adopted to the terminal in the manner of presetting or in the manner of system message configuration.

Preferably, when the base station 80 and the terminal 90 do not preset a corresponding relationship between the characteristic of the uplink access signal and an uplink beam and the base station 80 does not notify the corresponding relationship between the characteristic of the uplink access signal and the uplink beam to the terminal in the manner of system message configuration,

the sending module 902 in the terminal 90 is further configured to carry the index of the uplink beam in the characteristic of the uplink access signal corresponding to the index of the downlink beam.

The solutions of the abovementioned respective embodiments may be combined in certain manners to generate some combined solutions, and the combined solutions of the respective solution in the disclosure all fall within the scope of protection of the disclosure.

There are many methods for the terminal to detecting an optimal sequence in the disclosure, they are all detection implementation methods, and for example, a sequence-correlated method is adopted to select a sequence index with the highest correlation value to be fedback. Different sequence indexes may be selected according to different criterions, and there are no limits to the inventive idea of the disclosure. Any detection method shall fall within the scope of protection of the disclosure as long as one or more optimal values may be calculated and corresponding index values may be obtained. Those skilled in the art should understand that the embodiments of the disclosure may be provided as methods, systems or computer program products. Therefore, the disclosure may adopt a form of hardware embodiment, software embodiment or embodiment combining software and hardware. Moreover, the disclosure may adopt a form of computer program product implemented on one or more computer-available storage media (including, but not limited to, a disk memory, an optical memory and the like) containing computer-available program codes.

The disclosure is described with reference to flowcharts and/or block diagrams of the method, equipment (system) and computer program product according to the embodiment of the disclosure. It should be understood that each flow and/or block in the flowcharts and/or the block diagrams and combinations of the flows and/or blocks in the flowcharts and/or the block diagrams may be implemented by computer program instructions. These computer program instructions may be provided to a general purpose computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of guiding the computer or the other programmable data processing equipment to operate in a specific manner, so that a product containing an instruction device may be generated by the instructions stored in the computer-readable memory, the instruction device realizing the function specified in one flow or more flows in the flowcharts and/or one block or more blocks in the block diagrams.

These computer program instructions may also be loaded onto the computer or the other programmable data processing equipment, so that a series of operating steps are executed on the computer or the other programmable equipment to generate processing implemented by the computer, and steps for realizing the function specified in one flow or more flows in the flowcharts and/or one block or more blocks in the block diagrams are provided by the instructions executed on the computer or the other programmable equipment.

Correspondingly, the embodiment of the disclosure further provides a computer storage medium having stored therein a computer program for executing the method for mixedly indicating uplink and downlink beams at the base station side or the method for mixedly indicating uplink and downlink beams at the terminal side according to the embodiments of the disclosure.

The above are only the preferred embodiments of the disclosure and not intended to limit the scope of protection of the disclosure.

### INDUSTRIAL APPLICABILITY

According to the embodiments of the disclosure, the base station may obtain the optimal downlink beam fed back by the terminal, thereby ensuring reliable transmission of subsequent downlink control information. In addition, if an uplink beam transmission is introduced, the base station may detect an uplink access signal, with optimal uplink access signal quality, of the terminal and then notify a corresponding index to the terminal, and the terminal may obtain an optimal uplink beam from the terminal to the base station by obtaining the index of the uplink beam.

What is claimed is:

1. A method for mixedly indicating uplink and downlink beams, comprising:
notifying, by a base station, a corresponding relationship between a characteristic of an uplink access signal and an index of an uplink beam and/or an index of a downlink beam in a manner of presetting and/or a manner of system message configuration, the characteristic of the uplink access signal indicating the index of the uplink beam for sending the uplink access signal, and/or the index of the downlink beam; and
identifying, by the base station, the characteristic of the uplink access signal to obtain the index of the uplink beam and/or the index of the downlink beam after receiving the uplink access signal,
wherein the characteristic of the uplink access signal comprises at least one of: a time-domain position of the uplink access signal, a frequency-domain position of the uplink access signal, a set of sequences adopted for the uplink access signals, bit information for indicating index carried after the uplink access signal and a beam identification sequence carried after the uplink access signal.

2. (canceled)

3. The method according to claim 2, wherein a method for the base station to identify the index of the uplink beam and/or the index of the downlink beam comprises at least one of:
performing identification through the time-domain position of the received uplink access signal;
performing identification through the frequency-domain position of the received uplink access signal;
performing identification through the set of sequences adopted for the received uplink access signals;
performing identification through the bit information for indicating index carried after the received uplink access signal; and
performing identification through the beam identification sequence carried after the received uplink access signal.

4. The method according to claim 3, when identifying, by the base station, the index of the uplink beam and/or the index of the downlink beam through the time-domain position, the method further comprising:
adding, by the base station, a corresponding relationship between the time-domain position and the index of the uplink beam and/or the index of the downlink beam into a system message when configuring the system message.

5. The method according to claim 3, when identifying, by the base station, the index of the uplink beam and/or the index of the downlink beam through the frequency-domain position, the method further comprising:
adding, by the base station, a corresponding relationship between the frequency-domain position and the index of the uplink beam and/or the index of the downlink beam into a system message when configuring the system message.

6. The method according to claim 3, when identifying, by the base station, the index of the uplink beam and/or the index of the downlink beam through a sequence adopted for an uplink access signal, the method further comprising:
adding, by the base station, a corresponding relationship between the set of sequences adopted for the uplink access signals and the index of the uplink beam and/or the index of the downlink beam into a system message when configuring the system message.

7. A method for mixedly indicating uplink and downlink beams, comprising:
sending, by a terminal, an uplink access signal after obtaining a corresponding relationship between a characteristic of the uplink access signal and an index of an uplink beam and/or an index of a downlink beam in a manner of presetting and/or a manner of receiving system message configuration, the characteristic of the uplink access signal indicating the index of the uplink beam corresponding to an uplink beam for the terminal to send the uplink access signal, and/or the index of the downlink beam to be fed back.

8. (canceled)

9. The method according to claim 7, wherein the characteristic of the uplink access signal comprises at least one of: a time-domain position of the uplink access signal, a frequency-domain position of the uplink access signal, a set of sequences adopted for the uplink access signals, bit information for indicating index carried after the uplink access signal and a beam identification sequence carried after the uplink access signal.

10. The method according to claim 9, wherein a method for the terminal to indicate the index of the uplink beam and/or the index of the downlink beam comprises at least one of:
sending the uplink access signal at a preset time-domain position;
sending the uplink access signal at a preset frequency-domain position;
selecting a corresponding sequence from a preset set of sequences to send the uplink access signal according to the set of sequences;
carrying, when sending the uplink access signal, the bit information indicating the index of the uplink beam and/or the index of the downlink beam; and
carrying, when sending the uplink access signal, the beam identification sequence for indicating the index of the uplink beam and/or the index of the downlink beam.

11. The method according to claim 7, further comprising:
obtaining, by the terminal, a beam indication manner in a manner of presetting, or
obtaining, by the terminal, a beam indication manner through a received system message configuration.

12. (canceled)

13. The method according to claim 10, when indicating, by the terminal, the index of the uplink beam and/or the index of the downlink beam by virtue of the time-domain position where the uplink access signal is sent, the method further comprising:
obtaining, by the terminal, a corresponding relationship between the time-domain position and the index of the uplink beam and/or the index of the downlink beam from a system message after receiving the system message.

14. The method according to claim 10, when indicating, by the terminal, the index of the uplink beam and/or the index of the downlink beam by virtue of the frequency-domain position where the uplink access signal is sent, the method further comprising:
obtaining, by the terminal, a corresponding relationship between the frequency-domain position and the index of the uplink beam and/or the index of the downlink beam from the system message after receiving the system message.

15. The method according to claim 10, when indicating, by the terminal, the index of the uplink beam and/or the index of the downlink beam by virtue of a sequence adopted for an uplink access signal, the method further comprising:
obtaining, by the terminal, a corresponding relationship between the set of sequences adopted for the uplink access signals and the index of the uplink beam and/or the index of the downlink beam from the system message after receiving the system message.

16-24. (canceled)

25. A base station, comprising: a configuration sending module and a receiving identification module, wherein
the configuration sending module is configured to notify a corresponding relationship between a characteristic of an uplink access signal and an index of an uplink beam and/or an index of a downlink beam in a manner of presetting and/or a manner of system message configuration, the characteristic of the uplink access signal indicating the index of the uplink beam for sending the uplink access signal, and/or the index of the downlink beam; and
the receiving identification module is configured to identify the characteristic of the uplink access signal to obtain the index of the uplink beam and/or the index of the downlink beam after receiving the uplink access signal,
wherein the characteristic of the uplink access signal comprises at least one of: a time-domain position of the uplink access signal, a frequency-domain position of the uplink access signal, a set of sequences adopted for the uplink access signals, bit information for indicating index carried after the uplink access signal and a beam identification sequence carried after the uplink access signal.

26. (canceled)

27. The base station according to claim 26, wherein the operation that the receiving identification module identifies the index of the uplink beam and/or the index of the downlink beam comprises at least one of that:
the receiving identification module performs identification through the time-domain position of the received uplink access signal;
the receiving identification module performs identification through the frequency-domain position of the received uplink access signal;
the receiving identification module performs identification through the set of sequences adopted for the received uplink access signals;
the receiving identification module performs identification through the bit information for indicating index carried after the received uplink access signal; and
the receiving identification module performs identification through the beam identification sequence carried after the received uplink access signal.

28. The base station according to claim 27, wherein when the receiving identification module identifies the index of the uplink beam and/or the index of the downlink beam through the time-domain position,
the configuration sending module is further configured to add a corresponding relationship between the time-domain position and the index of the uplink beam and/or the index of the downlink beam into a system message when configuring the system message.

29. The base station according to claim 27, wherein when the receiving identification module identifies the index of the uplink beam and/or the index of the downlink beam through the frequency-domain position,
the configuration sending module is further configured to add a corresponding relationship between the frequency-domain position and the index of the uplink beam and/or the index of the downlink beam into a system message when configuring the system message.

30. The base station according to claim 27, wherein when the receiving identification module identifies the index of the uplink beam and/or the index of the downlink beam through a sequence adopted for an uplink access signal,
the configuration sending module is further configured to add a corresponding relationship between the set of sequences adopted for the uplink access signals and the index of the uplink beam and/or the index of the downlink beam into a system message when configuring the system message.

31. A terminal, comprising: a receiving module and a sending module, wherein
the receiving module is configured to obtain a corresponding relationship between a characteristic of the uplink access signal and an index of an uplink beam and/or an index of a downlink beam in a manner of presetting and/or a manner of receiving system message configuration; and
the sending module is configured to send the uplink access signal, the characteristic of the uplink access signal indicating the index of the uplink beam corresponding to an uplink beam for the terminal to send the uplink access signal, and/or the index of the downlink beam to be fed back.

32. The terminal according to claim 31, wherein the receiving module is further configured to obtain a beam indication manner in a manner of presetting or a received system message configuration.

33. The terminal according to claim 31, wherein the characteristic of the uplink access signal comprises at least one of: a time-domain position of the uplink access signal, a frequency-domain position of the uplink access signal, a set of sequences adopted for the uplink access signals, bit information for indicating index carried after the uplink access signal and a beam identification sequence carried after the uplink access signal.

34. The terminal according to claim 33, wherein the operation that the sending module indicates the index of the uplink beam and/or the index of the downlink beam comprises at least one of:
sending the uplink access signal at a preset time-domain position;
sending the uplink access signal at a preset frequency-domain position;
selecting a corresponding sequence from a preset set of sequences to send the uplink access signal according to the set of sequences;
carrying, when sending the uplink access signal, the bit information indicating the index of the uplink beam and/or the index of the downlink beam; and
carrying, when sending the uplink access signal, the beam identification sequence indicating the index of the uplink beam and/or the index of the downlink beam.

35. The terminal according to claim 34, wherein when the sending module indicates the index of the uplink beam and/or the index of the downlink beam by virtue of the time-domain position where the uplink access signal is sent,
the receiving module is further configured to obtain a corresponding relationship between the time-domain position and the index of the uplink beam and/or the index of the downlink beam from a system message after receiving the system message.

36. The terminal according to claim 34, wherein when the sending module indicates the index of the uplink beam and/or the index of the downlink beam by virtue of the frequency-domain position where the uplink access signal is sent,
the receiving module is further configured to obtain a corresponding relationship between the frequency-domain position and the index of the uplink beam and/or the index of the downlink beam from a system message after receiving the system message.

37. The terminal according to claim 34, wherein when the sending module indicates the index of the uplink beam and/or the index of the downlink beam by virtue of a sequence adopted for an uplink access signal,
the receiving module is further configured to obtain a corresponding relationship between the set of sequences adopted for the uplink access signals and the index of the uplink beam and/or the index of the downlink beam from a system message after receiving the system message.

38-41. (canceled)

42. A computer storage medium having stored therein a computer program for executing the method for mixedly indicating uplink and downlink beams according to claim 1.
